(19) United States
(12) Patent Application Publication
(10) Pub. No.: US 2016/0132124 A1
(43) Pub. Date: May 12, 2016

(54) GESTURE DETERMINATION APPARATUS AND METHOD, GESTURE OPERATION APPARATUS, PROGRAM, AND RECORDING MEDIUM

(71) Applicant: MITSUBISHI ELECTRIC CORPORATION, Tokyo (JP)

(72) Inventors: Yudai NAKAMURA, Tokyo (JP); Nobuhiko YAMAGISHI, Tokyo (JP); Tomonori FUKUTA, Tokyo (JP); Yoshiaki KUSUNOKI, Tokyo (JP)

(73) Assignee: MITSUBISHI ELECTRIC CORPORATION, Tokyo (JP)

(21) Appl. No.: 14/897,595

(22) PCT Filed: Apr. 10, 2014
(86) PCT No.: PCT/JP2014/060392

§ 371 Date: Dec. 10, 2015

(30) Foreign Application Priority Data
Aug. 2, 2013 (JP) 2013-161419

(51) Int. Cl. G06F 3/01; G06K 9/62; G06T 7/60; G06T 7/20; G06K 9/00; G06K 9/52

(52) U.S. Cl. CPC G06F 3/017; G06K 9/00355; G06K 9/52; G06T 7/60; G06T 7/20; G06K 9/6201

(57) ABSTRACT

A hand region (Rh) of an operator is detected from a captured image, and positions of a palm center (Po) and a wrist center (Wo) are determined, and origin coordinates (Cho) and a direction of an coordinate axis (Chu) of a hand coordinate system are calculated. A shape of the hand in the hand region (Rh) is detected using the hand coordinate system, and a shape feature quantity (D14) of the hand is calculated. Further, a movement feature quantity (D15f) of a finger is calculated based on the shape feature quantity (D14) of the hand. Gesture determination is made based on the calculated feature quantities. Since the gesture determination is made taking into consideration the differences in the angle of the hand placed in the operation region, and the direction in which the hand is moved, misrecognition of the operation can be reduced.

### TECHNICAL FIELD

The present invention relates to a gesture determination apparatus and method and a gesture operation apparatus. The invention also relates to a program and a recording medium.

### BACKGROUND ART

Gesture operation by shape or movement of a hand, which enables operations to be performed without using a remote controller or touching an operation panel, is effective for operating home electrical appliances, vehicle mounted devices, and other such devices. One problem in the gesture operation, however, is the difficulty of distinguishing between the operator's conscious actions (actions intended as operation inputs) and unconscious actions (actions not intended as operation inputs). A proposed solution to this problem is to designate an operation region near the operator and recognize only actions performed in the operation region as gestures made consciously by the operator. In particular, designating a fixed operation region causes no great inconvenience to the operator in an environment such as the interior of a vehicle or airplane, in which the operator's position is restricted (for example, patent references 1 and 2).

### PRIOR ART REFERENCES

### Patent References

Patent reference 1: Japanese Patent Application Publication 2004-142656

Patent reference 2: Japanese Patent Application Publication 2005-250785

Patent reference 3: International Publication WO2011/142317 [0004]

Patent reference 3 will be mentioned later.

### SUMMARY OF THE INVENTION

### Problem to be Solved by the Invention

A problem, however, is that if the operation region is fixed, differences may arise in the angle of the hand or the direction of a hand-waving action in the operation region, due to differences in the relative position of the operator with respect to the operation region, the body size, or the way the hand is placed in the operation region.

The present invention addresses this situation, and its object is to accurately and reliably detect the shape of the hand of the operator or the movement of the hand or a finger, by making a gesture determination, taking into account differences in the hand angle or in the direction of the hand-waving action in the operation region, thereby reducing operation misrecognition and executing precisely the operation that the operator intends.

### Means for Solving the Problem

A gesture determination apparatus of a first aspect of this invention comprises:

a hand region detection unit for detecting a hand region of an operator from a captured image and outputting hand region information indicating the detected hand region;

a coordinate system setting unit for setting an origin coordinate of a hand coordinate system and at least one coordinate axis of said hand coordinate system from a position of a particular part of a hand of the operator, based on said hand region information;

a movement feature quantity calculation unit for calculating a movement feature quantity of the hand of the operator on a basis of said hand coordinate system; and

a gesture determination unit for determining a gesture type, and calculating a gesture feature quantity, from the movement feature quantity of the hand.

A gesture determination apparatus of a second aspect of this invention comprises:

a hand region detection unit for detecting a hand region of an operator from a captured image and outputting hand region information indicating the detected hand region;

a coordinate system setting unit for setting an origin coordinate of a hand coordinate system and at least one axis of said hand coordinate system from a particular part of a hand of the operator, based on said hand region information;

a shape feature quantity calculation unit for identifying, as a finger candidate region, a part of the hand region indicated by said hand region information that satisfies a condition determined using said hand coordinate system, detecting a hand shape in the identified finger candidate region, and calculating a shape feature quantity representing a feature of the hand shape;

a movement feature quantity calculation unit for performing at least one of a calculation of a movement feature quantity of the hand of the operator on a basis of said hand coordinate system and a calculation of a movement feature quantity of a finger of the operator on a basis of said hand coordinate system and the shape feature quantity; and

a gesture determination unit for determining a gesture type, and calculating a gesture feature quantity, from at least one of the movement feature quantity of the hand and the movement feature quantity of the finger, and from the shape feature quantity.

### Effects of the Invention

According to this invention, the movement feature quantity of the hand, or the shape feature quantity of the hand and the movement feature quantity of the hand or finger, are calculated on the basis of the hand coordinate system, so that the gesture determination can be made with fewer misrecognitions even if, for example, the angle at which the hand is placed in the operation region or the direction of a hand-waving action differs depending on the operator, and the operation of the device based on the gesture determination can be made to be in accordance with the operator's intention.

### BRIEF DESCRIPTION OF THE DRAWINGS

FIG. 1 is a diagram showing an example of the use of a gesture operation apparatus in a first embodiment of the invention.

FIG. 2 is a block diagram of the gesture operation apparatus in the first embodiment.

FIG. 3 is a diagram illustrating a captured image coordinate system and a hand coordinate system in the first embodiment.

FIG. 4 is a diagram showing palm features calculated by a coordinate system setting unit 13 used in the first embodiment.

FIG. 5 is a diagram illustrating a procedure by which the coordinate system setting unit 13 used in the first embodiment identifies the wrist position.

FIG. 6 is a diagram illustrating a procedure by which the coordinate system setting unit 13 used in the first embodiment sets the hand coordinate system.

FIG. 7 is a diagram showing exemplary parameters of the hand coordinate system output by the coordinate system setting unit 13 used in the first embodiment.

FIGS. 8(a) to 8(c) are diagrams showing exemplary hand coordinate systems set by the coordinate system setting unit 13 used in the first embodiment.

FIG. 9 is a diagram illustrating the calculation of shape feature quantities by a shape feature quantity calculation unit 14 used in the first embodiment.

FIG. 10 is a diagram illustrating the calculation of movement feature quantities by a movement feature quantity calculation unit 15 used in the first embodiment.

FIG. 11 is a diagram showing an exemplary correspondence between gesture types and commands in the first embodiment.

FIG. 12 is a diagram showing another exemplary correspondence among a gesture type, a gesture parameter, and commands in the first embodiment.

FIG. 13 is a flowchart illustrating a processing procedure in a gesture operation method executed by the gesture operation apparatus in the first embodiment.

FIG. 14 is a block diagram of a gesture operation apparatus according to a second embodiment of the invention.

FIG. 15 is a flowchart illustrating a processing procedure in a gesture operation method executed by the gesture operation apparatus according to the second embodiment.

FIG. 16 is a block diagram of a gesture operation apparatus according to a third embodiment of the invention.

FIG. 17 is a flowchart illustrating a processing procedure in a gesture operation method executed by the gesture operation apparatus according to the third embodiment.

FIG. 18 is a block diagram of a gesture operation apparatus according to a fourth embodiment of the invention.

FIG. 19 is a diagram illustrating a captured image coordinate system and a hand coordinate system in the fourth embodiment.

FIG. 20 is a diagram illustrating the calculation of movement feature quantities by the movement feature quantity calculation unit 15 used in the fourth embodiment.

### MODE FOR CARRYING OUT THE INVENTION

### First Embodiment

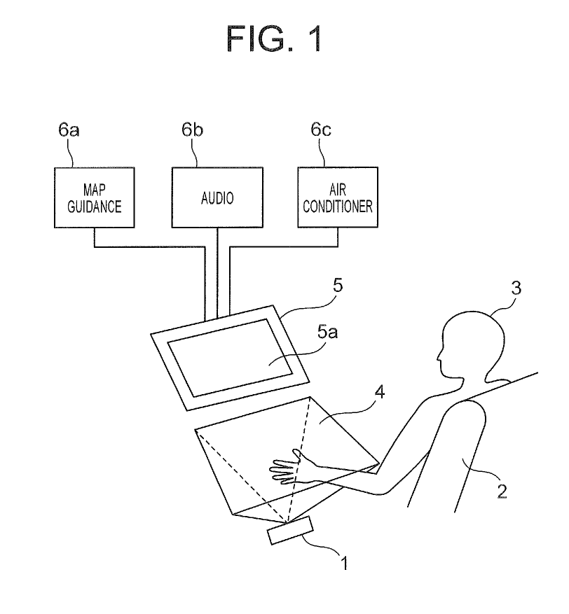

FIG. 1 is a diagram showing an example of the use of a gesture operation apparatus in a first embodiment of this invention. The illustrated gesture operation apparatus 1 recognizes gestures performed by an operator 3 in a predetermined operation region 4 within a hand-reachable range of the operator 3 who is seated in a seat 2 such as the driver's seat, a front passenger's seat, or a back seat in a vehicle, and issues operation instructions through an operation control unit 5 to vehicle mounted devices 6a, 6b, 6c, which constitute a plurality of operated devices.

The operated devices envisioned below are a map guidance device (an automotive navigation device) 6a, an audio device 6b, and an air conditioner (an air conditioning device) 6c. The operation instructions to the map guidance device 6a, the audio device 6b, and the air conditioner 6c are prompted by operation guidance displayed on a display section 5a of the operation control unit 5, and operation input according to the operation guidance is carried out by means of the gesture operation apparatus 1.

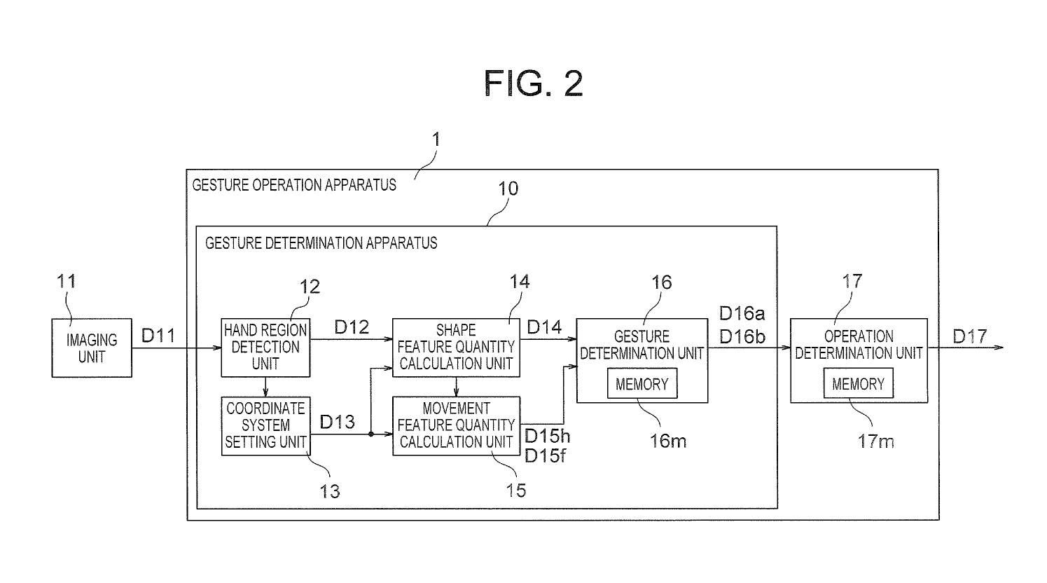

FIG. 2 is a block diagram showing the configuration of the gesture operation apparatus 1 according to the present embodiment. The illustrated gesture operation apparatus 1 is provided with an imaging unit 11, a gesture determination apparatus 10, and an operation determination unit 17. The gesture determination apparatus 10 is provided with a hand region detection unit 12, a coordinate system setting unit 13, a shape feature quantity calculation unit 14, a movement feature quantity calculation unit 15, and a gesture determination unit 16.

First a general description of the gesture operation apparatus 1 will be given.

The imaging unit 11 images a space including the operation region 4 at a predetermined frame rate, generates a series of frames of image data D11 representing a moving picture of this space, and outputs the generated image data D11 to the hand region detection unit 12.

The imaging unit 11 includes, for example, an image sensor or a distance sensor, and outputs an image such as a color image, a gray scale image, a bi-level image, or a distance image. In cases where the brightness of the imaged space is inadequate, the imaging unit may have functions for illuminating the imaged space with near infrared light, capturing the reflected light with a near infrared image sensor, and outputting the image.

The hand region detection unit 12 detects the operator's hand, when placed in the operation region 4, from the image data D11 received from the imaging unit 11, extracts a hand region Rh from the image, and generates information (hand region information) D12 indicating the extracted hand region Rh.

The hand region information D12 is image data in which only the extracted hand region Rh is labeled with a high level, and other regions are labeled with a low level: for example, image data in which pixels in the hand region Rh have a first pixel value such as ‘1’ and pixels in other regions have a second pixel value such as ‘0’.

The hand region detection unit 12 extracts the region Rh of the operator's hand from the image by applying, for example, a pattern recognition method, a background differential method, a skin color extraction method, and a frame-to-frame differential method or the like to the input image data D11.

The hand region information D12 generated by the hand region detection unit 12 is supplied to the coordinate system setting unit 13 and the shape feature quantity calculation unit 14.

From the hand region information D12 received as input, the coordinate system setting unit 13 determines the origin coordinates of the hand coordinate system in the coordinate system of the captured image (referred to below simply as the ‘image coordinate system’) and the relative angle of the hand coordinate system with respect to the image coordinate system, and outputs information representing these as hand coordinate system parameters D13 to the shape feature quantity calculation unit 14 and the movement feature quantity calculation unit 15.

On the basis of the hand coordinate system parameters D13 supplied from the coordinate system setting unit 13, the shape feature quantity calculation unit 14 calculates, from the hand region information D12, either one or both of fingertip positions and the number M of extended fingers as a feature quantity (a shape feature quantity) representing the shape of the hand, and outputs information (shape feature quantity information) D14 indicating the calculated shape feature quantity, to the movement feature quantity calculation unit 15 and the gesture determination unit 16.

The movement feature quantity calculation unit 15 calculates a feature quantity (a hand movement feature quantity) representing movement of the hand (movement of the entire hand) and generates hand movement feature quantity information D15h representing the hand movement feature quantity, on the basis of the hand coordinate system parameters D13 supplied from the coordinate system setting unit 13; calculates a feature quantity (a finger movement feature quantity) representing movement of a finger or fingers and generates the finger movement feature quantity information D15f representing the finger movement feature quantity, on the basis of the hand coordinate system parameters D13 supplied from the coordinate system setting unit 13 and the shape feature quantity information D14 supplied from the shape feature quantity calculation unit 14; and outputs the generated hand movement feature quantity information D15h and the finger movement feature quantity information D15f to the gesture determination unit 16.

The gesture determination unit 16 compares the shape feature quantity information D14 received from the shape feature quantity calculation unit 14 and the movement feature quantity information D15h, D15f received from the movement feature quantity calculation unit 15 with reference values D14r, D15hr, D15fr predefined for the respective quantities, discriminates the type of gesture from the comparison results, generates parameters pertaining to the gesture, and outputs information D16a indicating the type of gesture and the parameters D16b pertaining to the gesture, to the operation determination unit 17.

On the basis of the information D16a indicating the type of gesture and the parameters D16b pertaining to the gesture output from the gesture determination unit 16, the operation determination unit 17 generates a command D17, and outputs the command to the operation control unit 5.

The command D17 is an operation instruction for the operated device 6a, 6b, 7c, or an instruction to the operation control unit 5 for selecting the operated device in advance of the operation.

The operation control unit 5 displays a screen (operation screen) that displays guidance for selecting and operating the operated device; the operator 3 performs operation input by gesture according to the guidance on the operation screen. The operation input by gesture is carried out by placing the hand in the operation region 4, forming the hand into a predetermined shape, and moving the entire hand in a predetermined pattern, or moving a finger or fingers in a predetermined pattern.

The operation of the coordinate system setting unit 13, the shape feature quantity calculation unit 14, the movement feature quantity calculation unit 15, the gesture determination unit 16, and the operation determination unit 17 will now be described in more detail.

From the hand region information D12 supplied from the hand region detection unit 12, the coordinate system setting unit 13 determines the origin coordinates of the hand coordinate system in the image coordinate system (the relative position of the origin of the hand coordinate system with respect to the origin of the image coordinate system) and the relative angle (angle of rotation) of the hand coordinate system with respect to the image coordinate system, and outputs information representing these items as the hand coordinate system parameters D13 to the shape feature quantity calculation unit 14 and the movement feature quantity calculation unit 15.

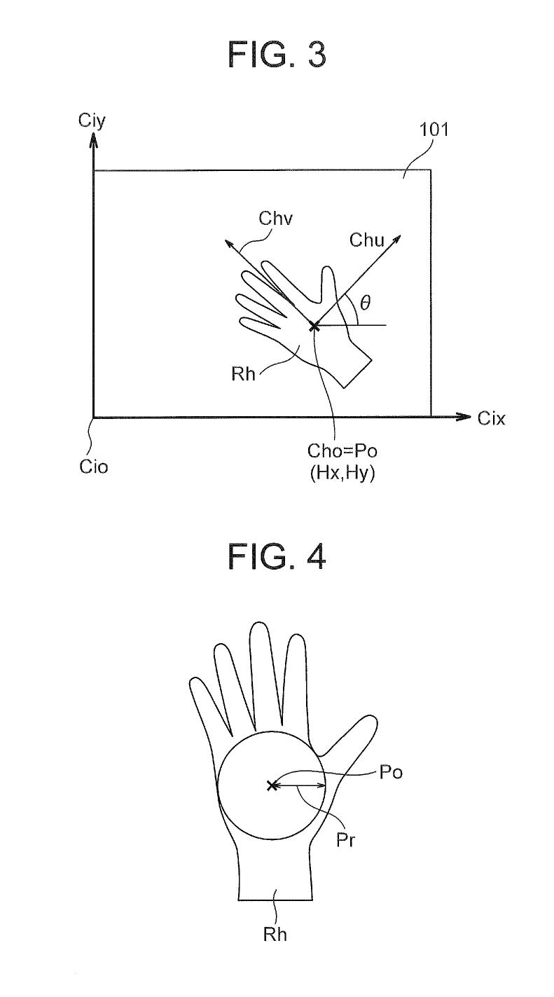

The image coordinate system and the hand coordinate system used in the first embodiment will be described here by use of FIG. 3.

FIG. 3 illustrates relations between the image coordinate system Ci and the hand coordinate system Ch.

The image coordinate system Ci is a coordinate system referenced to the image acquired by the imaging unit 11, and is an orthogonal coordinate system and also a right-handed coordinate system. In the rectangular image 101 shown in FIG. 3, for example, the origin Cio of the image coordinate system Ci can be set in the lower left of the image, the horizontal axis Cix can be set as a first axis, and the vertical axis Ciy can be set as a second axis.

The hand coordinate system Ch is a coordinate system referenced to the hand region Rh in the image, and is an orthogonal coordinate system and also a right-handed coordinate system. In the hand region Rh shown in FIG. 3, for example, the origin Cho of the hand coordinate system is set at the palm center Po, and a first axis Chu and a second axis Chv passing through the origin are set.

In FIG. 3, the hand indicated by the hand region Rh is drawn in the same orientation as in FIG. 1. This is an image obtained when the hand in the operation region 4 is imaged from above. If the gesture operation apparatus 1 is positioned below the operation region 4 as shown in FIG. 1 and the imaging unit 11 accordingly images the operation region 4 from below, the image shown in FIG. 3 is obtained by reversing left and right in the image obtained by imaging by the imaging unit 11. The image obtained by this left-right reversal will be used in the description below. The reason is that this left-right reversal allows us to contemplate an image seen from above the hand in the operation region 4, that is, an image seen from the same point of view as seen by the operator.

The component on the first axis Cix in the image coordinate system Ci will be denoted x, the component on the second axis Ciy will be denoted y, and the coordinates of each point will be denoted (x, y).

The component on the first axis Chu in the hand coordinate system Ch will be denoted u, the component on the second axis Chv will be denoted v, and the coordinates of each point will be denoted (u, v).

The coordinates in the image coordinate system Ci of the origin Cho of the hand coordinate system Ch (the relative position of the origin of the hand coordinate system with respect to the origin Cio of the image coordinate system) are represented by (Hx, Hy), and the angle (relative angle) of the first axis Chu of the hand coordinate system with respect to the first axis Cix of the image coordinate system is represented by θ.

The coordinate system setting unit 13 determines the coordinates (Hx, Hy) of the origin Cho of the hand coordinate system Ch in the image coordinate system Ci, and also determines the direction of the first axis Chu and the direction of the second axis Chv of the hand coordinate system in the image coordinate system Ci. Specifically, it determines the center Po of the palm as the origin Cho of the hand coordinate system Ch, and determines the directions of the first axis Chu and the second axis Chv of the hand coordinate system Ch from the direction of a vector directed from the wrist center to the palm center.

First, the coordinate system setting unit 13 calculates palm feature quantities from the hand region information D12. As shown in FIG. 4, the palm center Po and the palm radius Pr are calculated as palm feature quantities.

For example, for each point in the hand region Rh, the shortest distance to the perimeter of the hand region Rh is found, and the point for which this shortest distance is the greatest is calculated as the coordinates (Hx, Hy) of the palm center Po. And, the shortest distance from the palm center Po to the perimeter of the hand region Rh is calculated as the palm radius Pr.

The method of calculating the palm center is not limited to the above-mentioned method; for example, the center of the largest square that fits within the hand region may be used as the palm center, as taught in patent reference 3.

Next, the coordinate system setting unit 13 calculates the position of the wrist from the hand region information D12 and the calculated palm feature quantities (the palm center Po and the palm radius Pr).

Specifically, the coordinate system setting unit 13 first determines, from the palm feature quantities, a wrist search path Ss for identifying a wrist region. Next, from a feature quantity of the thickness of the wrist, it identifies the wrist region Rw on the search path Ss, and calculates the position Wo of the wrist center.

First, on the basis of the hand region information D12, the coordinate system setting unit 13 searches a region outside the palm, and identifies the wrist region from the difference in the thickness between the fingers and the wrist.

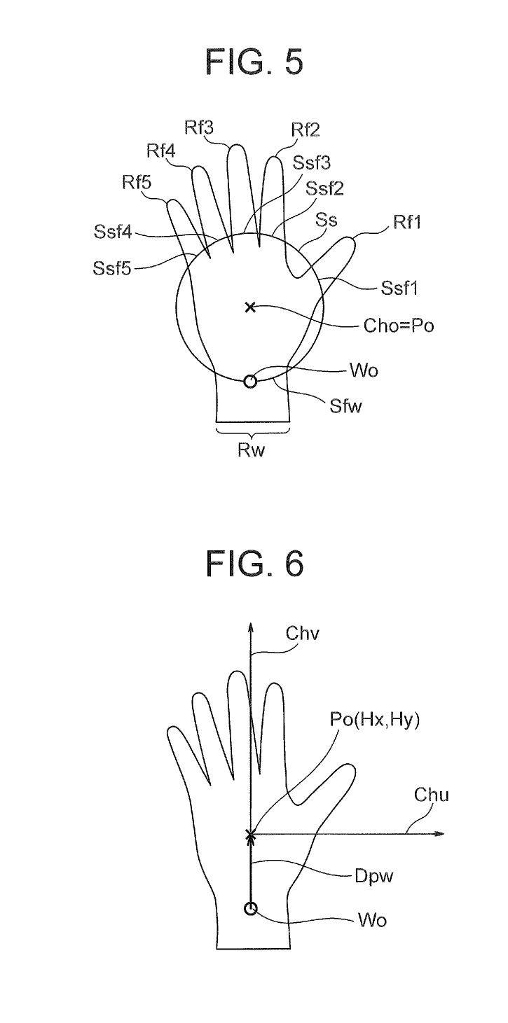

Specifically, in the image including the hand region indicated by the hand region information D12, a circle shown in FIG. 5, centered at the palm center Po and having a radius of α×Pr, is drawn as the search path Ss. The search path Ss can be drawn outside the palm by setting the coefficient α by which the palm radius Pr is multiplied, so as to satisfy α>1. This enables the search to be made for the wrist region positioned outside the palm. The image including the hand region is searched along this search path Ss to see where the search path Ss and the hand region Rh overlap. The value of α is set at, for example, α=1.2.

The search path Ss is a set of points having coordinates (x, y) that satisfy the relation in the formula (1) below.

[ Mathematical Expression 1]

(x−Hx)²+(y−Hy)²=(α·Pr)² (1)

Performance of the search as described above produces respective overlaps of the search path Ss and the hand region Rh (places where the search path Ss crosses the hand region Rh) in the wrist region Rw and the extended finger regions Rf1 to RfM (where M is the number of extended fingers). If attention is paid to the lengths of the parts of the search path Ss that overlap the hand region Rh, the thickness of the wrist is greater than the thicknesses of the fingers, the length of the part Ssw of the search path Ss that overlaps the wrist region Rw is greater than the palm radius Pr and the lengths of the parts Ssfm of the search path Ss that overlap the finger regions Rfm are less than the palm radius Pr.

The coordinate system setting unit 13 therefore records the search path lengths in the overlapping parts of the search path Ss and the hand region Rh (the lengths of the parts of the search path that cross the hand region Rh) and identifies the wrist region by comparing the overlapping length of the search path in each overlapping part with the palm radius. Specifically, at each overlap of the search path Ss and the hand region Rh it assigns an index i (iε1, . . . , N) to the overlapping part and records the lengths f[1], . . . , f[N] of the search path in the overlapping parts. Here, N indicates the number of overlapping parts of the search path Ss and the hand region Rh. For example, if the length of the search path in the first overlap is F1, then f[1]=F1 is recorded, and if the length of the search path in the second overlap is F2, then f[2]=F2 is recorded. As the ‘length of the part of the search path Ss that overlaps the hand region Rg’, the length measured along the arc of the search path may be used, or, the length of a straight line connecting the starting and ending points of the overlap may be used.

Each of the lengths f[i] recorded as described above is compared with the palm radius, and the part satisfying

f[i]>β×Pr

is identified as the wrist region. The coefficient β by which the palm radius Pr is multiplied is preferably set so as to satisfy β≧1, so that a part of the search path Ss overlapping the hand region Rh and having a length equal to or greater than the palm radius Pr can be identified. For example, β is set to be equal to 1.0.

The coordinate system setting unit 13 calculates the center of the overlap of the search path Ss with the wrist region identified in this way as the coordinates (Wx, Wy) of the center Wo of the wrist.

Although a circular search path Ss is used in the example described above, the invention is not limited thereto, and the shape of the search path may be any other shape provided it permits the search to take place outside the palm; for example, it may be a polygon such as, for example, a hexagon or an octagon.

The coordinate system setting unit 13 sets the center coordinates (Hx, Hy) of the palm calculated as described above as the origin coordinates of the hand coordinate system in the image coordinate system, and determines the directions of the first axis Chu and the second axis Chv from the center coordinates (Hx, Hy) of the palm and the center coordinates (Wx, Wy) of the wrist.

That is, the coordinate system setting unit 13 determines the coordinates (Hx, Hy) of the palm center Po in the image coordinate system as the origin Cho (u=0, v=0) of the hand coordinate system, as shown in FIG. 6.

Next, the direction 90 degrees clockwise from the direction of a vector Dpw directed from the wrist center Wo to the palm center Po is determined to be the direction of the first axis Chu of the hand coordinate system, and the direction of the above-mentioned vector Dpw is determined to be the direction of the second axis Chv of the hand coordinate system.

The directions of the first axis Chu and the second axis Chv of the hand coordinate system are not restricted to the example described above; they may be set to any directions referenced to a vector directed from the wrist center Wo to the palm center Po.

When the directions of the first axis Chu and the second axis Chv of the hand coordinate system have been determined, the coordinate system setting unit 13 outputs information indicating those directions. For example, it outputs information indicating the relative angle θ of the hand coordinate system with respect to the image coordinate system.

The angle formed by the first axis Cix of the image coordinate system and the first axis Chu of the hand coordinate system, for example, may be used as the relative angle of the hand coordinate system with respect to the image coordinate system; alternatively, the angle formed by the second axis Ciy of the image coordinate system Ci and the second axis Chv of the hand coordinate system Ch may be used. More generally, the angle formed by either one of the first axis Cix and the second axis Ciy of the image coordinate system Ci and either one of the first axis Chu and the second axis Chv of the hand coordinate system Ch may be used.

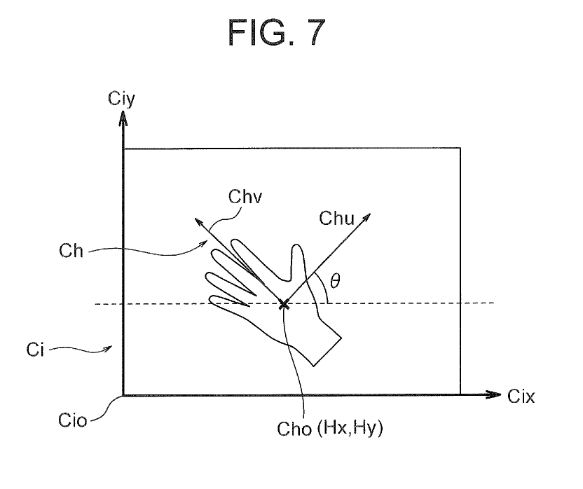

In the following description, the counterclockwise angle formed by the first axis Chu of the hand coordinate system Ch with respect to the first axis Cix of the image coordinate system Ci, as illustrated in FIG. 7, will be used as the relative angle θ of the hand coordinate system Ch with respect to the image coordinate system Ci.

The information indicating the above-mentioned relative angle θ is output together with information indicating the origin coordinates (Hx, Hy) of the hand coordinate system in the image coordinate system as the hand coordinate system parameters D13.

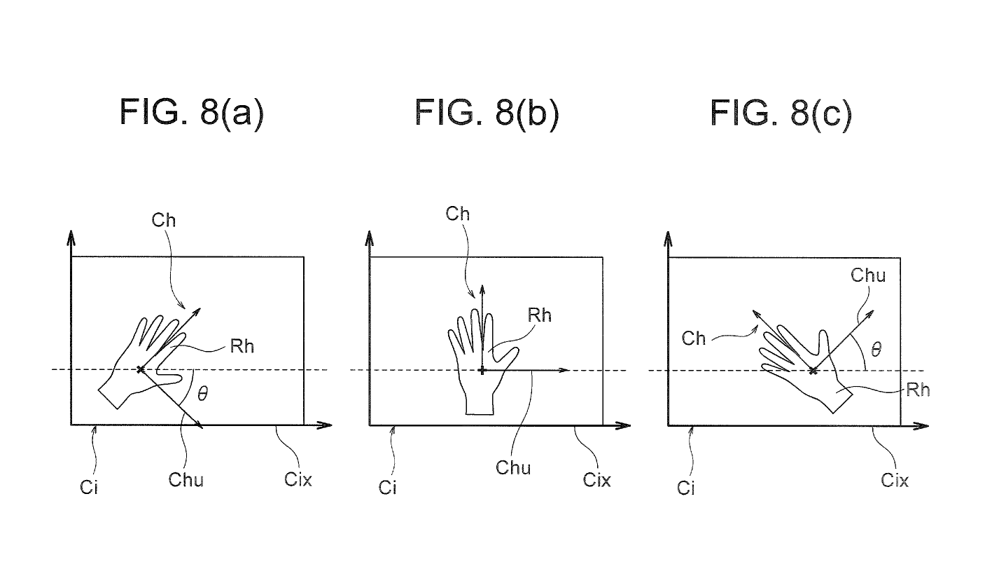

Exemplary hand coordinate systems set at mutually differing relative angles with respect to the image coordinate system are shown in FIGS. 8(a) to 8(c). In the example in FIG. 8(a), θ=−45°; in the example in FIG. 8(b), θ=0°; in the example in FIG. 8(c), θ=45°. The relative angle θ of the hand coordinate system is defined with reference to the direction of a vector directed from the wrist center Wo to the palm center Po, as described above, so that FIGS. 8(a) to 8(c) are set for mutually differing angles of the hand.

If the origin of the hand coordinate system Ch in the image coordinate system Ci is represented by (Hx, Hy), the relative angle of the first axis Chu of the hand coordinate system Ch with respect to the first axis Cix of the image coordinate system Ci is represented by θ, and the unit length is the same in the hand coordinate system Ch and the image coordinate system Ci, the coordinates (x, y) of each point in the image coordinate system Ci can be converted to coordinates (u, v) in the hand coordinate system Ch by the conversion formulas (2A) and (2B) below.

[ Mathematical Expression 2]

u=(x−Hx)·cos θ+(y−Hy)·sin θ (2A)

v=(x−Hx)·(−sin θ)+(y−Hy)·cos θ (2B)

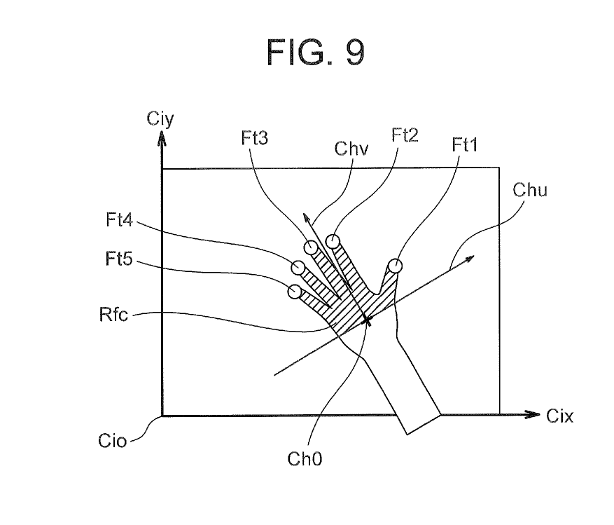

Next, the processing in the shape feature quantity calculation unit 14 will be described by use of FIG. 9. FIG. 9 shows the first axis Chu and the second axis Chv of the hand coordinate system Ch, a finger candidate region Rfc, and the fingertip positions Ft1-FtM. Here, M is the number of extended fingers; in the example shown in FIG. 9, M=5.

From the hand region information D12, the shape feature quantity calculation unit 14 calculates either one or both of the coordinates of the position or positions of a fingertip or fingertips Ftm (m being any of 1 to M) and the number M of extended fingers as feature quantities (shape feature quanties) representing the shape of the hand.

In the calculation of the shape feature quantities, the position of a fingertip Ftm is preferably expressed by coordinates (u, v) in the hand coordinate system Ch.

For this purpose, the shape feature quantity calculation unit 14 uses the parameters D13 indicating the origin coordinates and the directions of the first axis and the second axis in the hand coordinate system Ch to convert the coordinates in the image coordinate system that express the position of each pixel in the captured image to coordinates in the hand coordinate system. This conversion is carried out by the computation according to the formulas (2A) and (2B).

The identification of the extended fingers is carried out as follows.

First, a region consisting of pixels satisfying a prescribed condition in relation to the axes Chu, Chv of the hand coordinate system Ch is identified as a region (candidate region) Rfc in which fingers may be present.

For example, since the fingers are located in the positive direction of the second axis Chv in the hand coordinate system Ch with respect to the palm center Po, the region, within the hand region Rh, in which the coordinate component v in the second axis direction satisfies v>0 is set as the finger candidate region Rfc. In other words, taking the origin Cho of the hand coordinate system as a reference point, the hand region Rh located in the range of from 0 to 180 degrees counterclockwise from the first axis Chu is set as the finger candidate region Rfc.

Next, the shape feature quantity calculation unit 14 calculates the coordinates of the fingertips Ftm in the finger candidate region Rfc thus set, and the number M of extended fingers. For example, it identifies the fingertips Ftm from extensions and retractions in the perimeter of the finger candidate region, and calculates coordinates indicating their positions.

For that purpose, the distance from the palm center Po to each point on the perimeter of the finger candidate region Rfc is calculated. For each perimeter point, this distance is compared with that of neighboring perimeter points, and a perimeter point with a greater distance than the perimeter points on both sides (a perimeter point with a local maximum distance) is identified as a fingertip candidate point Ftcm.

The distance from the palm center Po to a fingertip Ftm is greater than the palm radius Pr. Letting Du denote the distance from the palm center Po to a fingertip candidate point Ftmc, fingertip candidate points satisfying

Du>γ×Pr

are identified as true fingertips Ftm.

If the coordinates of a fingertip candidate point Ftmc are represented by (u, v), then the distance Du from the palm center Po to the fingertip candidate point Ftmc is determined from the following formula (3).

[ Mathematical Expression 3]

Du=\sqrt{u²+v²} (3)

By setting the coefficient γ by which the palm radius Pr is multiplied, so as to satisfy γ≧1, points at which the distance from the palm center Po is greater than the palm radius Pr can be identified as fingertips Ftm. The coordinates of the identified fingertips Ftm in the hand coordinate system Ch will be denoted (Fum, Fvm).

The shape feature quantity calculation unit 14 may also determine the number of the identified fingertips Ftm as the number M of extended fingers.

The shape feature quantity calculation unit 14 outputs either one or both of the coordinates (Fum, Fvm) of the detected fingertips Ftm and the number M of extended fingers, as the feature quantities (shape feature quantity information) expressing the shape of the hand D14, to the movement feature quantity calculation unit 15 and the gesture determination unit 16.

In the example described above, the fingertip identification is based on local maximum distances of the points on the perimeter of the hand region Rh from the palm center, but the invention is not limited to this method; the fingertips may be identified by the use of other methods, such as pattern matching or polygonal approximation methods, for example.

The coordinates of the fingertips may also be calculated as coordinates (Fxm, Fym) in the image coordinate system.

As described above, the shape feature quantity calculation unit 14 performs finger identification based on hand shape feature quantities in the finger candidate region Rfc restricted on the basis of the hand coordinate system, so that the probability of mistaking non-finger regions for fingers is low.

The movement feature quantity calculation unit 15 calculates the hand movement feature quantities D15h and the finger movement feature quantities D15f.

As the hand movement feature quantities D15h, at least one of a hand velocity, a hand acceleration, and a hand movement amount (an amount of movement from a certain position (initial position), for example) is calculated; as the finger movement feature quantities D15f, at least one of a finger velocity, a finger acceleration, and a finger movement amount (an amount of movement from a certain position (initial position), for example) is calculated.

The velocities and movement amounts of these movements are calculated on the basis of differences in the position over at least two different time points. The accelerations are calculated on the basis of differences in the velocity over at least two different time points.

First, the finger movements will be described. The finger movement feature quantities D15f may be calculated for each of the extended fingers, or only for a representative finger, e.g., the middle finger.

In the case where the shape feature quantity calculation unit 14 calculates the fingertip positions in the hand coordinate system, the movement feature quantity calculation unit 15 calculates the velocity, the acceleration, and the movement amount in the hand coordinate system as the finger movement feature quantities D15f.

If the fingertip positions are expressed using coordinates in the image coordinate system, changes in the coordinates are a combination of a component due to the finger movement and a component due to the hand movement (movement of the entire hand), but if the fingertip positions are expressed using coordinates in the hand coordinate system, changes in the coordinates represent only the finger movement component. By use of the coordinates of the fingertip positions in the hand coordinate system in the calculation of the finger velocity, the finger acceleration, and the finger movement amount, the movement of the fingers with respect to the palm center can be separated from the movement of the entire hand, and the movement feature quantities. D15f of each finger can be calculated easily and in a short time.

Next, the hand movement is determined as follows.

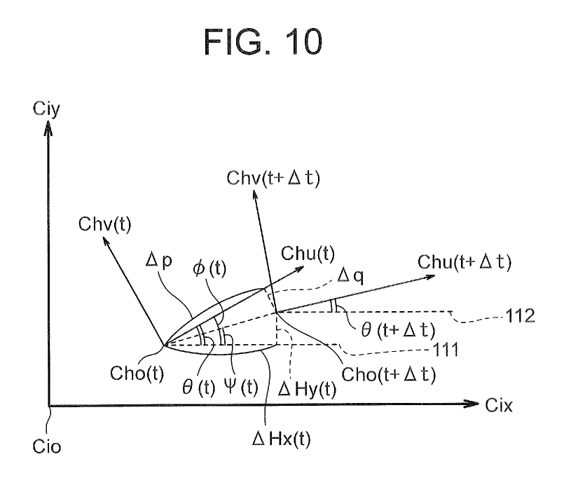

FIG. 10 illustrates changes in the hand coordinate system Ch when the hand is moved in the operation region 4.

If images are captured at intervals of a certain frame period (image capture period) Δt, for example, then in the hand coordinate system Ch(t) at a time point t (at a certain image frame (the j-th frame), for example) the origin coordinates thereof are indicated by (Hx(t), Hy(t)) and the relative angle thereof with respect to the image coordinate system is indicated by θ(t), while in the hand coordinate system Ch(t+Δt) at a time point t+Δt (at a frame (the (j+1)-th frame), for example, following the above-mentioned certain image frame) the origin coordinates thereof are indicated by (Hx(t+Δt), Hy(t+Δt)) and the relative angle thereof with respect to the image coordinate system is indicated by θ(t+Δt).

The movement feature quantity calculation unit 15 detects, for example, the movement of the palm center as the hand movement (movement of the entire hand).

Since the palm center is the origin of the hand coordinate system, it would always be zero, if the movement of the palm center were to be expressed in the hand coordinate system.

It is advantageous, however, to detect the movement of the palm center at each time point by separating the movement into a component in the direction of the first axis Chu of the hand coordinate system and a component in the direction of the second axis Chv of the hand coordinate system, that is, a component in the direction of the relative angle θ and a component in the direction of the relative angle θ+90 degrees with respect to the first axis Cix in the image coordinate system Ci. This is because the components in these directions represent, respectively, the movement in a direction perpendicular to a straight line connecting the wrist center and the palm center and the movement in the direction of the straight line connecting the wrist center and the palm center, and when the hand is moved, it is easier for the operator to perceive and control the direction of movement with reference to the above-mentioned two directions of the operator's own hand than with reference to directions in the image generated by the imaging unit 11 (directions in the image plane of the imaging unit 11).

In the present embodiment, accordingly, when the hand movement, for example, the movement of the palm, is detected, the position of the palm center at a certain time point, for example, the time point when tracking of the movement begins, is taken as a starting point, and the movement amount per small interval of time (movement amount between consecutive frames) Δp in the direction of the above-mentioned relative angle θ at each subsequent time point is integrated to calculate a movement amount p, while the movement amount Δq in the direction of the above-mentioned relative angle θ+90 degrees per small interval of time is integrated to calculate a movement amount q. The movement amounts p, q determined in this way will be referred to below as the ‘movement amounts in the directions of the first axis Chu(t) and the second axis Chv(t) of the hand coordinate system Ch(t) at each time point’. The above-mentioned movement amounts per unit time will be referred to as velocities, and the changes in the velocity per unit time will be referred to as accelerations.

These movement amounts p, q are determined as follows.

As shown in FIG. 10, if the origin and the relative angle of the hand coordinate at a time point t and a time point t+Δt change as shown in FIG. 10, then from the relations shown in FIG. 10, the movements Δp, Δq during this time Δt are given by the formulas below. Reference characters 111 and 112 in FIG. 10 indicate lines passing through the origins Cho(t) and Cho(t+Δt), respectively, of the coordinate, and extending parallel to the axis Cix.

[ Mathematical Expression 4]

Δp={square root over ((ΔHx(t)²+Hy(t)²)}·cos φ(t) (4)

Δq={square root over ((ΔHx(t)²+Hy(t)²)}·(−sin φ(t)) (5)

In the formulas (4) and (5),

[ Mathematical Expression 5]

ΔHx(t)=Hx(t+Δt)−Hx(t) (6)

ΔHy(t)=Hy(t+Δt)−Hy(t) (7)

and φ(t) is the angle formed by the direction of the first axis Chu of the hand coordinate system and the direction of movement of the origin, and is given by the formula (8).

[ Mathematical Expression 6]

φ(t)=θ(t)−Ψ(t) (8)

In the formula (8), ‘Ψ’(t) is the angle formed by the direction of movement of the origin of the hand coordinate system and the first axis Cix of the image coordinate system, and is given by the following formula (9).

[ Mathematical Expression 7]

$$ψ ( t ) = arctan ( \frac{Δ Hy ( t )}{Δ Hx ( t )} ) \qquad ( 9 )$$

By integrating the Δp and Δq shown in the formulas (4) and (5), the movement amount p in the direction of the first axis Chu(t) and the movement amount q in the direction of the second axis Chv(t) at each time point can be determined.

As shown in FIG. 10, for example, in circular movement of the palm centered around a point on an extension of the straight line connecting the palm center and the wrist, e.g., around the elbow joint (this type of circular movement is performed in hand-waving actions, for example), the movement amount p gradually increases over time while the movement amount q remains zero. If the movement is not perfectly circular but deviates slightly from circular movement, the movement amount q is still close to zero.

In contrast, if the palm is moved along the straight line connecting the palm center and the wrist, the movement amount q gradually increases over time while the movement amount p remains zero. If the movement is not perfectly linear but deviates slightly from linear movement, the movement amount p is still close to zero.

In these cases, the angle φ shown in FIG. 10 remains constant or nearly constant.

The angle φ also remains substantially constant when the movement continues in a direction, not necessarily the above-mentioned direction, that forms a constant or substantially constant angle with respect to the straight line connecting the wrist and the palm.

Thus when the movement is made in such a direction that the direction of movement is easy for the operator to perceive, the value of the movement amount p or the movement amount q is zero or a value near zero, or the angle φ is substantially constant, identification of the feature quantity of the movement can be made easily.

In the example described above, amounts of change in the central position of the palm are detected as the hand movement feature quantities D15h, but the invention is not limited to this scheme; for example, amounts of changes in the position of the center of gravity of the hand region Rh may be detected, or amounts of change in the position of some other part of the hand may be detected as the hand movement feature quantities D15h.

Thus with regard to the finger movement, the movement feature quantity calculation unit 15 converts the components of respective coordinates in the image coordinate system to coordinate components in the hand coordinate system, calculates the finger movement feature quantities D15f, and outputs them to the gesture determination unit 16.

With regard to the hand movement, the movement feature quantity calculation unit 15 converts the components of respective coordinates in the image coordinate system to coordinate components in the hand coordinate system at each time point, that is, to a component in a direction perpendicular to the straight line connecting the wrist center and the palm center (the component in the direction of θ) and a component in the direction of that straight line (the component in the direction of θ+90 degrees), uses the converted data to calculate the hand movement feature quantities D15h, and outputs the calculated results to the gesture determination unit 16.

The gesture determination unit 16 determines the gesture type on the basis of the hand shape feature quantities input from the shape feature quantity calculation unit 14 and the movement feature quantities D15h, D15f input from the movement feature quantity calculation unit 15, outputs the information D16a indicating the determination result to the operation determination unit 17, calculates feature quantities of the gesture, and outputs information representing the calculated feature quantities, as the parameters D16b pertaining to the gesture, to the operation determination unit 17.

Hand shapes such as the ‘rock’, ‘scissors’, and ‘paper’ shapes, hand movements such as a hand-waving movement, finger movements such as the one similar to the gripping of a dial between fingertips, or combinations of a hand shape and a hand or finger movement can be cited here as exemplary types of gestures.

For the purpose of recognizing and discriminating these gestures, conditions to be satisfied by the above-mentioned shape feature quantities and/or movement feature quantities are predefined before execution of the gesture determination process and are stored in a memory, for example, in a memory 16m in the gesture determination unit 16, and at the time of gesture determination process, whether the shape feature quantities and the movement feature quantities calculated by the shape feature quantity calculation unit 14 and the movement feature quantity calculation unit 15 on the basis of the image data D11 output from the imaging unit 11 satisfy the conditions stored in the memory 16m is determined, and the gesture recognition is madeon the basis of the determination results.

Examples of the gesture feature quantities include the coordinates of the fingertips when the hand shape determination is made, the time for which a particular hand shape is maintained, the hand velocity when the determination that the hand is waved is made, and so on.

First, the gesture determination from the hand shape will be described.

For example, in the gesture determination from the hand shape, a determination that a certain type of gesture (for input of a certain operation) has been performed is made when the state in which a predetermined number M of fingers are extended is maintained for a predetermined time Ts or more.

For the purpose of that determination, ‘the state in which a predetermined number M of fingers are extended is maintained for a predetermined time Ts or more’ is predefined as a condition to be satisfied and stored in the memory 16m. During the gesture determination process, when the hand shape feature quantities calculated by the shape feature quantity calculation unit 14 based on the image data D11 output from the imaging unit 11 satisfy the above-mentioned condition, the gesture determination unit 16 determines that the certain type of gesture mentioned above has been performed.

For example, in a case where a determination of the ‘scissors’ gesture with two fingers extended is made, the condition that the state in which the number M of fingers extended as a hand shape feature quantity is two is maintained for the predetermined time Ts is stored in the memory 16m as a condition to be satisfied.

During the gesture determination process, when information indicating that the number M of extended fingers, as a hand shape feature quantity calculated by the shape feature quantity calculation unit 14 from the image data D11 output from the imaging unit 11 is two continues (continues to be input to the gesture determination unit 16, for example) for the time Ts or more, the gesture determination unit 16 determines that the ‘scissors’ gesture has been performed.

If the time Ts is too short, operator's actions not intended as operation input are likely to be misrecognized as gestures for operation input, due to oversensitivity to the hand shape presented by the operator. The longer the time Ts is, however, the longer the time for gesture recognition becomes, so that responsiveness suffers. The time Ts is determined from these considerations and is set to, for example, 0.3 seconds.

Next, the gesture determination from the hand or finger movement will be described.

In the gesture determination from the hand movement, a determination that a certain type of gesture (a gesture for input of a certain operation) has been performed is made when the movement continues in a direction at a certain particular angle with respect to the straight line connecting the wrist center and the palm center in the image coordinate system (that is, a direction that forms certain particular angles with respect to the coordinate axes (Chu, Chv) of the hand coordinate system at each time point), and if the velocity of that movement, the time for which the movement continues, or the movement amount in the direction that forms the above-mentioned particular angle satisfies a predetermined condition (for example, that the movement in the certain particular direction in the hand coordinate system at each time point is within a predetermined velocity range and continues for a predetermined time or more).

For the purpose of that determination, with regard to the movement in a direction forming a certain particular angle with respect to the straight line connecting the wrist center and the palm center in the image coordinate system (that is, a direction that forms certain particular angles with respect to the coordinate axes (Chu, Chv) of the hand coordinate system at each time point), the condition to be satisfied by the velocity of the movement, the time for which the movement continues, or the movement amount in the direction that forms the above-mentioned particular angle is predefined and stored in the memory 16m.

During the gesture determination process, when the movement feature quantities calculated by the movement feature quantity calculation unit 15 from the image data D11 output from the imaging unit 11 satisfy the above-mentioned condition, a determination that the certain type of gesture mentioned above has been performed is made.

For example, in a case where the action of waving the hand toward the right (the action of rotating the hand toward the right, that is, counterclockwise, about the elbow) is determined to be a certain type of gesture, the continuation of movement with a velocity equal to or greater than a threshold value Vuth in a direction in the range of 90 degrees ±μ degrees (where μ is a predetermined tolerance) with respect to the straight line connecting the wrist center and the palm center in the image coordinate system (that is, a direction within ±μ degrees centered on the first axis Chu of the hand coordinate system at each time point) for a certain time Td or more is predefined as a condition to be satisfied and stored in the memory 16m; during the gesture determination process, when the movement feature quantities calculated by the movement feature quantity calculation unit 15 from the image data D11 output from the imaging unit 11 satisfy the above-mentioned condition, the gesture determination unit 16 determines that the gesture of waving the hand toward the right has been performed.

If the time Td is too short, operator's actions not intended as operation input are likely to be misrecognized as gestures for operation input, due to oversensitivity to the hand movement of the operator. The longer the time Td is, however, the longer the time for gesture recognition becomes, so that responsiveness suffers. The time Td is determined from these considerations and is set to, for example, 0.2 seconds.

The gesture type D16a determined by the gesture determination unit 16 and the parameters D16b pertaining to the gesture are output to the operation determination unit 17.

From the gesture type D16a and the parameters D16b pertaining to the gesture, which are input from the gesture determination unit 16, the operation determination unit 17 determines the content of the operation (the type and/or quantity of operation) directed, toward the operation control unit 5 or the operated devices 6a, 6b, 6c.

The process of determining the content of the operation directed toward the operation control unit 5 or the operated devices 6a, 6b, 6c from the gesture type and the gesture feature quantities will be described here by use of examples.

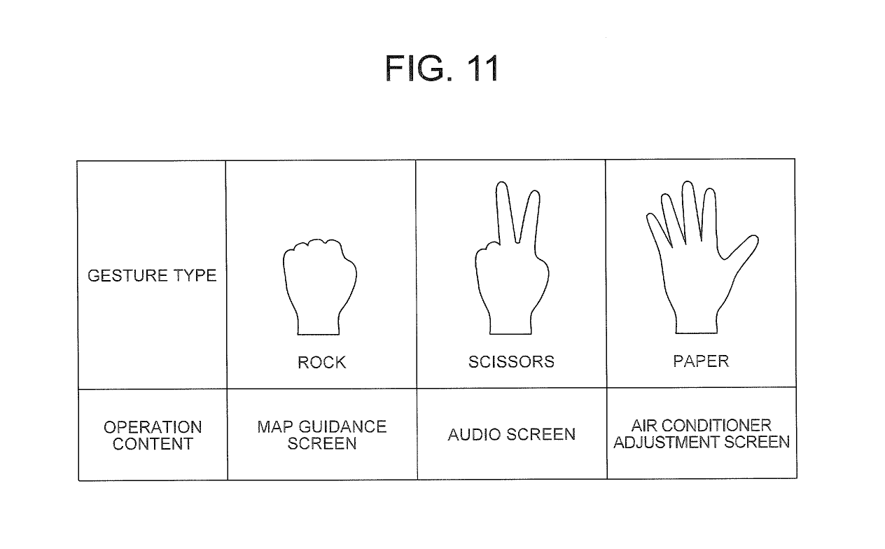

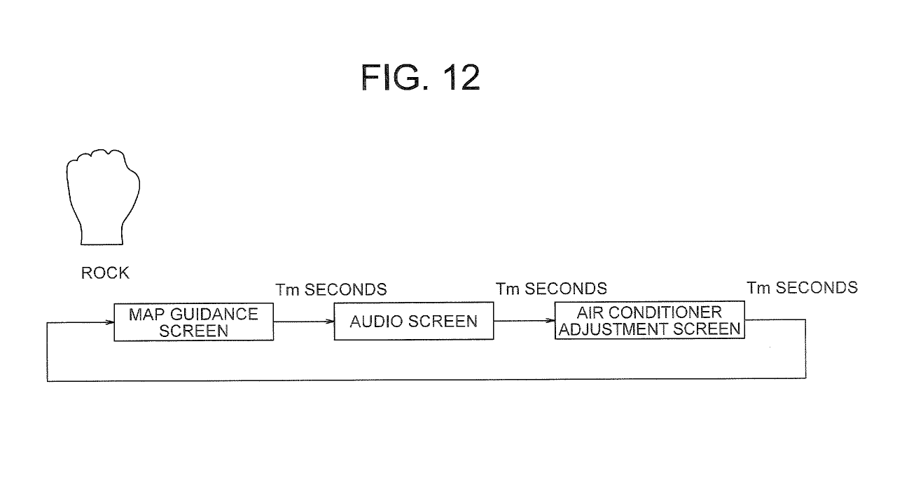

First, an example of the process of using hand shapes as a type of gesture to switch the content of the display (operation screen) on the display section 5a of the operation control unit 5 will be described by use of FIGS. 11 and 12.

Before the gesture determination process takes place, the hand shapes that are types of gestures and their correspondence to the switching of operation screens are predefined and stored in a memory, for example, a memory 17m in the operation determination unit 17. For example, the ‘rock’ gesture is made to correspond to the action of switching to a ‘map guidance’ screen, the ‘scissors’ gesture is made to correspond to the action of switching to an ‘audio screen’, and the ‘paper’ gesture is made to correspond to the action of switching to an ‘air conditioner adjustment screen’, as shown in FIG. 11.

‘Map guidance screen’ means an initial screen for map guidance; ‘audio screen’ means an initial screen for operating an audio function; ‘air conditioner adjustment screen’ means an initial screen for operating the air conditioner.

At the time of the gesture determination process, if a determination result that the ‘rock’ gesture has been performed is input to the operation determination unit 17 from the gesture determination unit 16, the operation determination unit 17 generates a command for switching the display content of the display section 5a to the ‘map guidance screen’ and outputs it to the operation control unit 5.

If a determination result that the ‘scissors’ gesture has been performed is input to the operation determination unit 17, the operation determination unit 17 generates a command for switching the display content of the display section 5a to the ‘audio screen’ and outputs it to the operation control unit 5.

If a determination result that the ‘paper’ gesture has been performed is input to the operation determination unit 17, the operation determination unit 17 generates a command for switching the display content of the display section 5a to the ‘air conditioner adjustment screen’ and outputs it to the operation control unit 5.

It is also possible to arrange for the hand shape and the gesture feature quantities to be used to switch the display content of the display section 5a of the operation control unit 5 sequentially. For example, the ‘rock’ gesture may be made to correspond to a switching in the display content, and each time the ‘rock’ gesture is maintained for a predetermined time, the display content (operation screen) that would be selected if the ‘rock’ gesture were to be terminated at that time point is changed in a predetermined sequence, for example, cyclically.

For example, it is possible to arrange so that, as shown in FIG. 12, while the operator is performing the ‘rock’ gesture, the display content of the display section 5a switches among the ‘map guidance screen’, the ‘audio screen’, the ‘air conditioner adjustment screen’, and so on at fixed intervals of Tm seconds. At each time point while the ‘rock’ gesture is maintained, which operation screen would be selected if the ‘rock’ gesture were to be terminated at that time point is displayed. This display may be made using a part or the entirety of the display screen of the display section 5a.

When the entire display screen is used, a display screen with the same content as the operation screen that will be selected may be displayed as a candidate, for example, and if the ‘rock’ gesture is terminated at that time point, the displayed candidate screen may be designated as the operation.

In these cases, when the ‘rock’ gesture is terminated, information selecting the screen having been displayed as a candidate screen at that time point is output to the operation control unit 5.

If the time Tm is too short, the screen changes so quickly that it becomes difficult to select the operation screen which the operator wants. The longer the time Tm is, however, the more time it takes for the screen to change, and the more likely it is that the operator will become impatient. The time Tm is determined from these considerations and is set to, for example, 1.0 seconds.

Next, an example of the relation between the hand movements and the operation content in a case in which the hand movement is used as a type of gesture will be described.

In the following, the operation in which the “map guidance” is selected and a guidance map is displayed on the display section 5a is scrolled horizontally will be described.

Before the gesture determination process is executed, the hand movements that are types of gestures and the feature quantities of those movements are made to correspond to the map scrolling directions, speeds, etc. and the correspondences are stored in a memory, for example, the memory 17m in the operation determination unit 17.

For example, as the gesture types, a wave of the hand toward the left is made to correspond to scrolling toward the left, and a wave of the hand toward the right is made to correspond to scrolling toward the right. That is, the direction in which the hand is waved is made to correspond to the scrolling direction.

As the movement feature quantity, the velocity with which the hand is waved is made to correspond to the scrolling speed. These correspondences are stored in the memory 17m.

At the time of the gesture determination process, if a determination result that the action of waving the hand toward the left has taken place and information indicating the velocity of the wave of the hand are input to the operation determination unit 17 from the gesture determination unit 16, the operation determination unit 17 generates a command for scrolling the map toward the left at a speed corresponding to the velocity with which the hand is waved, and outputs this command through the operation control unit 5 to the map guidance device 6a.

If a determination result that the action of waving the hand toward the right has taken place and information indicating the velocity of the wave of the hand are input to the operation determination unit 17 from the gesture determination unit 16, the operation determination unit 17 generates a command for scrolling the map toward the right at a speed corresponding to the velocity with which the hand is waved, and outputs this command through the operation control unit 5 to the map guidance device 6a.

In this way, on the basis of the output of the gesture determination unit 16, the operation determination unit 17 outputs a command corresponding to the gesture type and the gesture feature quantities to the operation control unit 5 or the operated devices 6a, 6b, 6c.

The operation determination unit 17 may be configured to output, in a similar manner, a command for a gesture that combines a hand shape with a hand or finger movement.

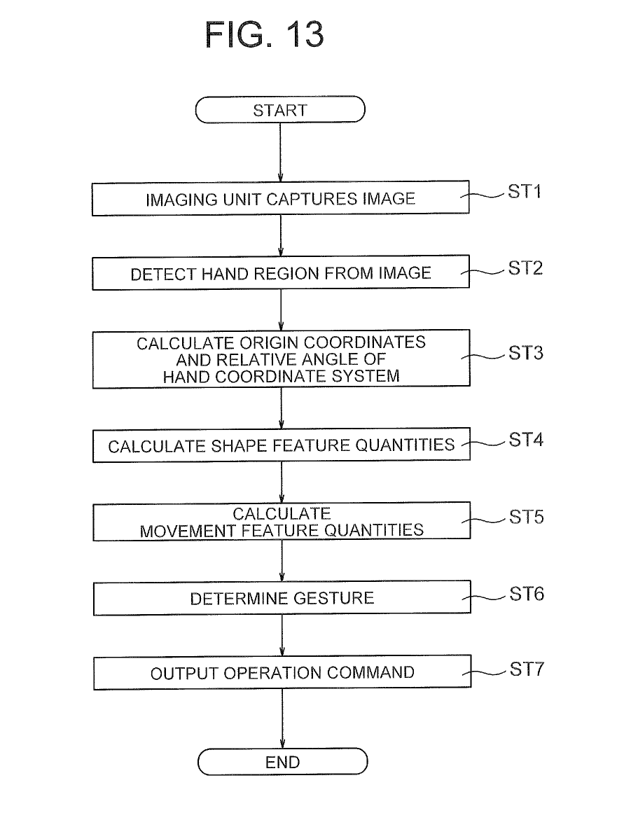

The processing procedure in the method (gesture operation method) carried out by the gesture operation apparatus 1 in the first embodiment will now be described by use of the flowchart in FIG. 13.

First, the imaging unit 11 images a space including the operation region 4 and generates images of this space (ST1).

Next, from the images supplied as input from the imaging unit 11, the hand region detection unit 12 detects the operator's hand region Rh placed in the operation region 4 and generates hand region information D12 (ST2).

The hand region information D12 generated in the step ST2 is sent to the coordinate system setting unit 13 and the shape feature quantity calculation unit 14.

In a step ST3, the coordinate system setting unit 13 sets the hand coordinate system on the basis of the hand region information D12 generated in the step ST2 and calculates the origin coordinates and the relative angle of the hand coordinate system.

The origin coordinates and the relative angle of the hand coordinate system calculated in the step ST3 are sent as the hand coordinate system parameters from the coordinate system setting unit 13 to the shape feature quantity calculation unit 14 and the movement feature quantity calculation unit 15.

In a step ST4, the shape feature quantity calculation unit 14 calculates the shape feature quantities D14, from the hand region information D12 output in the step ST2 and the origin coordinates and the relative angle of the coordinate system calculated in the step ST3, and sends information (shape feature quantity information) D14 representing the calculated shape feature quantities to the movement feature quantity calculation unit 15 and the gesture determination unit 16.

In a step ST5, the movement feature quantity calculation unit 15 calculates the hand movement feature quantities and the finger movement feature quantities, from the origin coordinates and the relative angle of the coordinate system calculated in the step ST3 and the shape feature quantity information D14 calculated in the step ST14, and sends information D15h, D15h representing these movement feature quantities to the gesture determination unit 16.

In a step ST6, the gesture determination unit 16 determines the gesture type and calculates the gesture feature quantities from the shape feature quantity information D14 calculated in the step ST4 and the movement feature quantities D15h, D15f calculated in the step ST5, and sends information D16a indicating the gesture type and the parameters D16b pertaining to the gesture to the operation determination unit 17.

In a step ST7, the operation determination unit 17 determines the content of the operation from the gesture type and the gesture feature quantities determined in the step ST6, and outputs a command indicating the content of the operation to the operation control unit 5 or one of the operated devices 6a, 6b, 6c, and the process ends.

In the gesture determination apparatus 10 according to the present embodiment configured as described above, the hand coordinate system is set by the coordinate system setting unit 13 and the hand shape feature quantities and the hand and finger movement feature quantities are calculated on the basis of the hand coordinate system, for example, the hand shape feature quantities and the finger movement feature quantities in the hand coordinate system are calculated and the hand movement feature quantities in particular directions in the hand coordinate system at each time point are calculated, so that accurate gesture determination, unaffected by differences in the angle of the hand in the operation region 4 and differences in the direction of movement in hand-waving actions and the like, which differ with the individual operator, can be made, with fewer misrecognitions.

In addition, setting the palm center as the origin of the hand coordinate system and setting the directions of the axes in the hand coordinate system from a direction vector directed from the wrist center to the palm center enables the hand coordinate system to be set accurately regardless of the angle at which the operator's hand is placed in the operation region.

In addition, since the shape feature quantity calculation unit 14 identifies a part of the hand region Rh indicated by the hand region information D12 that satisfies a condition predetermined based on the hand coordinate system as the finger candidate region Rfc, detects the fingertip positions in the identified finger candidate region Rfc, and calculates the feature quantities (shape feature quantities) representing the shape of the hand, the shape feature quantities can be calculated within the limited finger candidate region on the basis of the hand coordinate system, so that the possibility of misrecognizing non-finger regions as fingers can be reduced, and the amount of calculation can be reduced as compared with the case in which the candidate region is not restricted.

In addition, the movement feature quantity calculation unit 15 calculates the hand and finger movement feature quantities D15h, D15f on the basis of the hand coordinate system, for example, calculates the finger movement feature quantities D15f by using the coordinates in the hand coordinate system and calculates the hand movement feature quantities D15h on the basis of movement in the directions of the coordinate axes of the hand coordinate system or in a particular direction with respect to the coordinate axes, so that the feature quantities can be obtained in a stable manner, unaffected by operator dependent differences in the angle of the hand in the operation region 4 or the direction of movement in hand-waving actions or the like.

In addition, the gesture determination unit 16 determines the gesture type and calculates the gesture feature quantities on the basis of, for example, the hand shape feature quantities D14 and the finger movement feature quantities D15f in the hand coordinate system and the hand movement feature quantities D15h in particular directions in the hand coordinate system at each time point, the gesture determination with fewer misrecognitions can be made, without being affected by differences in the directions of the hand movements in the image coordinate system.

Since the gesture operation apparatus 1 according to the present embodiment carries out operations using the result of the determination made by the gesture determination apparatus 10 having the above-mentioned effects, precise operations can be performed based on precise determination results.

In the examples described above, the movement feature quantity calculation unit 15 calculates both the hand movement feature quantity information D15h and the finger movement feature quantity information D15f, but the movement feature quantity calculation unit 15 may be adapted to carry out only the calculation of the hand movement feature quantity information D15h or only the calculation of the finger movement feature quantity information D15f.

### Second Embodiment

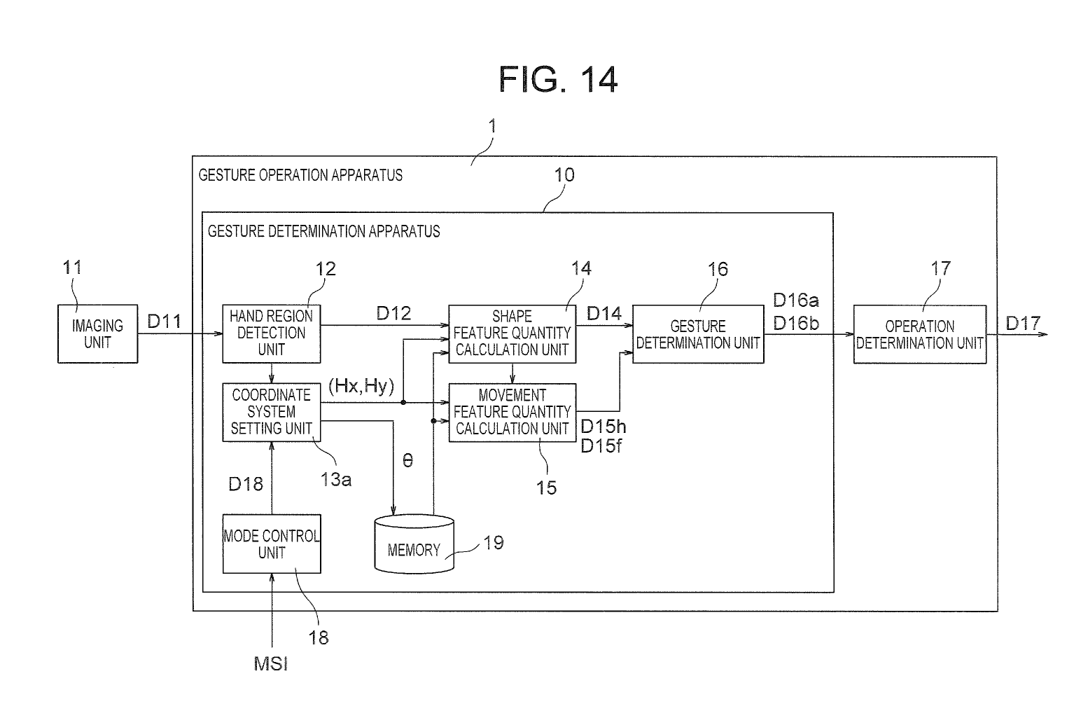

FIG. 14 is a block diagram showing the configuration of a gesture operation apparatus according to a second embodiment of this invention. The gesture operation apparatus shown in FIG. 14 is generally the same as the gesture operation apparatus shown in FIG. 2, and the reference characters that are the same as in FIG. 2 indicate the same or equivalent parts; the differences are that a mode control unit 18 and a memory 19 are added, and a coordinate system setting unit 13a is provided in place of the coordinate system setting unit 13 shown in FIG. 2.

First a general description of the apparatus will be given.

The mode control unit 18 receives mode selection information MSI from an external source and outputs mode control information D18 to the coordinate system setting unit 13a.

The coordinate system setting unit 13a receives the hand region information D12 from the hand region detection unit 12, receives the mode control information D18 from the mode control unit 18, and calculates the parameters of the hand coordinate system Ch from the images of the operation region including the hand on the basis of the hand region information D12 and the mode control information D18.

On the other hand, the coordinate system setting mode is selected by the mode control information D18, the coordinate system setting unit 13a calculates part of the coordinate system parameters, e.g., the relative angle, and has the memory 19 store the calculated relative angle θ.

That is, when the feature quantity calculation mode is selected by the mode control information D18, the coordinate system setting unit 13a calculates the remaining coordinate system parameters, e.g., the origin coordinates (Hx, Hy), on the basis of the hand region information D12 from the hand region detection unit 12, and outputs the calculated origin coordinates (Hx, Hy) to the shape feature quantity calculation unit 14 and the movement feature quantity calculation unit 15.

When the coordinate system setting mode is selected, the memory 19 receives the information representing the relative angle of the hand coordinate system with respect to the image coordinate system, from the coordinate system setting unit 13a, and stores the received information.

On the other hand, when the feature quantity calculation mode is selected, the relative angle θ stored in the memory 19 is read out and supplied to the shape feature quantity calculation unit 14 and the movement feature quantity calculation unit 15.

The shape feature quantity calculation unit 14 receives the hand region information D12 from the hand region detection unit 12, receives the information representing the origin coordinates (Hx, Hy) of the hand coordinate system from the coordinate system setting unit 13a, and receives the information representing the relative angle θ of the hand coordinate system with respect to the image coordinate system from the memory 19; calculates the shape feature quantities on the basis of the received information; and outputs the calculated shape feature quantities to the movement feature quantity calculation unit 15 and the gesture determination unit 16.

The movement feature quantity calculation unit 15 receives the hand region information D12 from the hand region detection unit 12, receives the information representing the origin coordinates (Hx, Hy) of the hand coordinate system from the coordinate system setting unit 13a, and receives the information representing the relative angle θ of the hand coordinate system with respect to the image coordinate system from the memory 19, calculates the movement feature quantities D15h, D15f on the basis of the received information, and outputs the calculated feature quantities to the gesture determination unit 16.

The processing in each part will now be described in more detail.

The mode control unit 18 generates the mode control information D18 on the basis of the mode selection information MSI input from the external source, and outputs the mode selection information MSI to the coordinate system setting unit 13a.

The mode selection information MSI is information, supplied from the external source, that pertains to the selection of the coordinate system setting mode: for example, mode designation information indicating whether to select the coordinate system setting mode or the feature quantity calculation mode.

The mode control information D18 is generated on the basis of the mode selection information MSI supplied from the external source: for example, a first value, e.g., ‘0’, is output when the coordinate system setting mode is selected and a second value, e.g., ‘1’, is output when the feature quantity calculation mode is selected.

Instead of the mode designation information indicating whether to select the coordinate system setting mode or feature quantity calculation mode, information (switchover information) instructing a switchover between the state in which the coordinate system setting mode is selected and the state in which the feature quantity calculation mode is selected may be input, as the mode selection information MSI, to the mode control unit 18.

There are, for example, the following three types of switchover information:

(a) information instructing a switchover from ‘the state in which the feature quantity calculation mode is selected’ to ‘the state in which the coordinate system setting mode is selected’;

(b) information instructing a switchover from ‘the state in which the coordinate system setting mode is selected’ to ‘the state in which the feature quantity calculation mode is selected’;

(c) information indicating that neither switchover (a) nor switchover (b) is necessary.

The mode control unit 18 receives the above-mentioned switchover information (a) to (c), determines the mode in which the operation is to be carried out at each time point, and outputs mode control information D18 based on the result of the determination.

The coordinate system setting unit 13a switches the content of its processing on the basis of the mode control information D18 received from the mode control unit 18.

When ‘0’ is received as the mode control information D18 from the mode control unit 18, that is, when the coordinate system setting mode is selected, the coordinate system setting unit 13a calculates the relative angle of the hand coordinate system from the hand region information D12 in the same way as described in connection with the coordinate system setting unit 13 in the first embodiment, and outputs the relative angle of the hand coordinate system with respect to the image coordinate system to the memory 19.

When ‘1’ is received as the mode control information D18 from the mode control unit 18, that is, when the feature quantity calculation mode is selected, the coordinate system setting unit 13a calculates the origin coordinates (Hx, Hy) of the hand coordinate system from the hand region information D12 in the same way as described in connection with the coordinate system setting unit 13 in the first embodiment (but without calculating the relative angle θ), and outputs the origin coordinates (Hx, Hy) to the shape feature quantity calculation unit 14 and the movement feature quantity calculation unit 15.

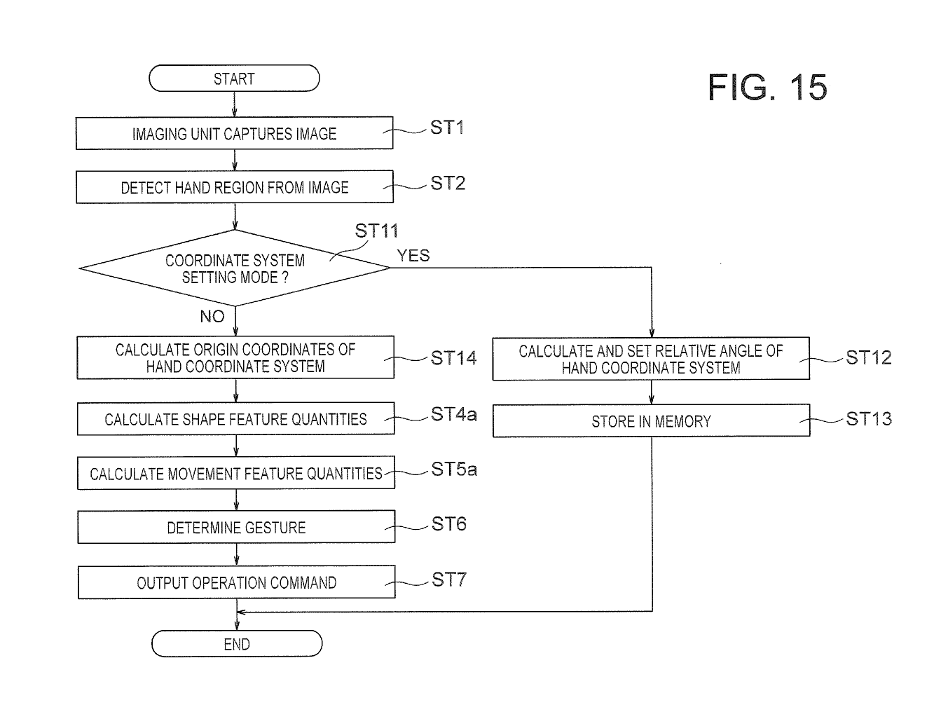

The processing procedure in the operation method executed by the gesture operation apparatus in the second embodiment will now be described by use of the flowchart in FIG. 15. Reference characters in the flowchart shown in FIG. 14 that are the same as in FIG. 13 denote the same or equivalent steps. The operation method shown in FIG. 15 is generally the same as the method shown in FIG. 13, but differs in the addition of steps ST11-ST13 and the inclusion of steps ST14, ST4a, and ST5a in place of the steps ST3-ST5. In FIG. 15, reference characters that are the same as in FIG. 13 denote the same or equivalent steps.

After the output of hand region information D12 in the step ST2, the mode control unit 18 decides, in the step ST11, whether the coordinate system setting mode is selected. This decision is made on the basis of the mode selection information MSI.

When the coordinate system setting mode is selected, the mode control unit 18 so informs the coordinate system setting unit 13a, and in the step ST12, the coordinate system setting unit 13a sets the relative angle of the hand coordinate system with respect to the image coordinate system from the hand region information D12 output in the step ST12.

In the step ST13, the coordinate system setting unit 13a has the memory 19 store the relative angle of the hand coordinate system output in the step ST12, and the process ends.

When the decision in the step ST11 is that the operator has selected the feature quantity calculation mode, the mode control unit 18 so informs the coordinate system setting unit 13a, and in the step ST14, the coordinate system setting unit 13a calculates the origin coordinates (Hx, Hy) of the hand coordinate system from the hand region information D12 output in the step ST2, sets the origin coordinates (Hx, Hy), and outputs the origin coordinates (Hx, Hy) to the shape feature quantity calculation unit 14 and the movement feature quantity calculation unit 15.

Next, in the step ST4a, the shape feature quantity calculation unit 14 calculates the shape feature quantities from the hand region information D12 output in the step ST2, the relative angle θ of the hand coordinate system with respect to the image coordinate system stored in the memory 19, and the origin coordinates (Hx, Hy) of the hand coordinate system set in the step ST14, and outputs the information (shape feature quantity information) D14 indicating the calculated shape feature quantities to the movement feature quantity calculation unit 15 and the gesture determination unit 16.

In the step ST5a, the movement feature quantity calculation unit 15 calculates the hand movement feature quantities D15h and the finger movement feature quantities D15f from the relative angle θ of the hand coordinate system with respect to the image coordinate system stored in the memory 19 and the origin coordinates (Hx, Hy) of the hand coordinate system set in the step ST14, and outputs the calculated movement feature quantities D15h, D15f to the gesture determination unit 16.

In the step ST6, the gesture determination unit 16 determines the gesture type and generates the parameters pertaining to the gesture, from the shape feature quantities calculated in the step ST4a and the movement feature quantities D15h, D15f calculated in the step ST5a, and sends these items to the operation determination unit 17. Only the hand movement feature quantities or only the finger movement feature quantities may be used as the movement feature quantities for determining the gesture type, as was also described in the first embodiment.

In the gesture determination apparatus 10 and the gesture operation apparatus 1 according to the present embodiment are configured as described above, the memory 19 is provided, so that the relative angle θ of the hand coordinate system can be stored.

Since the configuration has the mode control unit 18, either the mode in which the relative angle θ of the hand coordinate system is stored or the mode in which feature quantities are calculated by use of the stored relative angle θ can be selected.

As described above, whereas the processing carried out in the first embodiment treats the relative angle θ of the hand coordinate system as a quantity that varies with the hand-waving actions, in the second embodiment, the processing is made on the assumption is that the relative angle θ is unchanged when the coordinate system setting mode is not selected, that is, when the feature quantity calculation mode is selected.

When the operator 3 is seated in the seat 2, as long as the operator is the same person, although the origin coordinates of the hand coordinate system change each time the hand is placed in the operation region 4, the relative angle of the hand coordinate system with respect to the image coordinate system does not vary greatly.

Also, when a hand-waving action is performed, if the rotational angle of the waving movement is small the relative angle θ does not vary greatly, so that even if it is treated as fixed, the gesture determination can be carried out with adequately high precision.

In the second embodiment, therefore, the coordinate system setting unit 13a calculates the relative angle θ of the hand coordinate system with respect to the image coordinate system only when the coordinate system setting mode is selected, and has the calculated relative angle θ stored in the memory 19. When the feature quantity calculation mode is selected, the coordinate system setting unit 13a calculates only the origin coordinates of the hand coordinate system, reads the information indicating the relative angle θ of the hand coordinate system, that is, the information indicating the directions of the first axis and the second axis, from the memory 19, and uses the information thus read. This arrangement allows the process of calculating the relative angle of the hand coordinate system with respect to the image coordinate system whenever the hand region information D12 is received to be omitted, so that the gesture determination and the gesture operation can be implemented with a smaller amount of computation.

Since gesture operation can be implemented with a smaller amount of computation in this way, the process of the gesture operation apparatus of determining the gesture and generating a command to the operated device, responsive to the gesture operation carried out by the operator, can be speeded up. The operated device thus becomes more responsive to the operator's actions and more operator friendly.

In addition, since the gesture determination and the gesture operation can be implemented with a smaller amount of computation, they can be implemented on a lower-cost processing device with lower processing power, and the cost of the device can be reduced.

In the gesture determination apparatus 10 and the gesture operation apparatus 1 according to the present embodiment configured as described above, the mode control unit 18 controls the operation of the coordinate system setting unit 13a on the basis of the mode selection information MSI. The relative angle of the hand coordinate system with respect to the image coordinate system can therefore be set at an arbitrary timing, and stored in the memory 19. With this configuration, when a single operator uses the gesture operation apparatus, the relative angle of the hand coordinate system with respect to the image coordinate system can be set just once, and the information indicating that relative angle can then be used continuously. When a plurality of operators use the gesture operation apparatus, the relative angle of the hand coordinate system with respect to the image coordinate system can be set when the operator changes, and stored in the memory 19 for further use. That is, even when the operator changes, the gesture determination and the gesture operation can still be carried out with a smaller amount of computation.

The operator may use either the gesture operation apparatus of the present invention or another operation input apparatus to input the mode selection information MSI; or the coordinate system setting mode may be selected automatically when the operator initially starts using the gesture operation apparatus, and the selection of the coordinate system setting mode may be cleared automatically after the information indicating the relative angle of the hand coordinate system with respect to the image coordinate system is stored in the memory 19.

Also, switchovers between selection of the coordinate system setting mode and selection of the feature quantity calculation mode may be carried out periodically, or carried out automatically when some condition is satisfied, and each time the relative angle of the hand coordinate system is newly calculated in the coordinate system setting mode, the content stored in the memory 19 (the stored relative angle of the hand coordinate system) may be updated.

In the description given above, the information indicating the relative angle θ of the hand coordinate system is stored as part of the coordinate system parameters in the memory 19, but the present invention is not limited to this scheme; parameters other than the relative angle θ, such as parameters defining the directions of the first axis and the second axis in the hand coordinate system or parameters other than those mentioned above, may be stored in the memory 19; at any rate, any configuration in which part of the coordinate system parameters are stored in the coordinate system setting mode, and the stored parameters are read and used in the calculation of the shape feature quantities and the movement feature quantities in the feature quantity calculation mode is possible; in these cases as well, the computational load can be reduced because it is not necessary to calculate the parameters every time the feature quantities are calculated.

### Third Embodiment

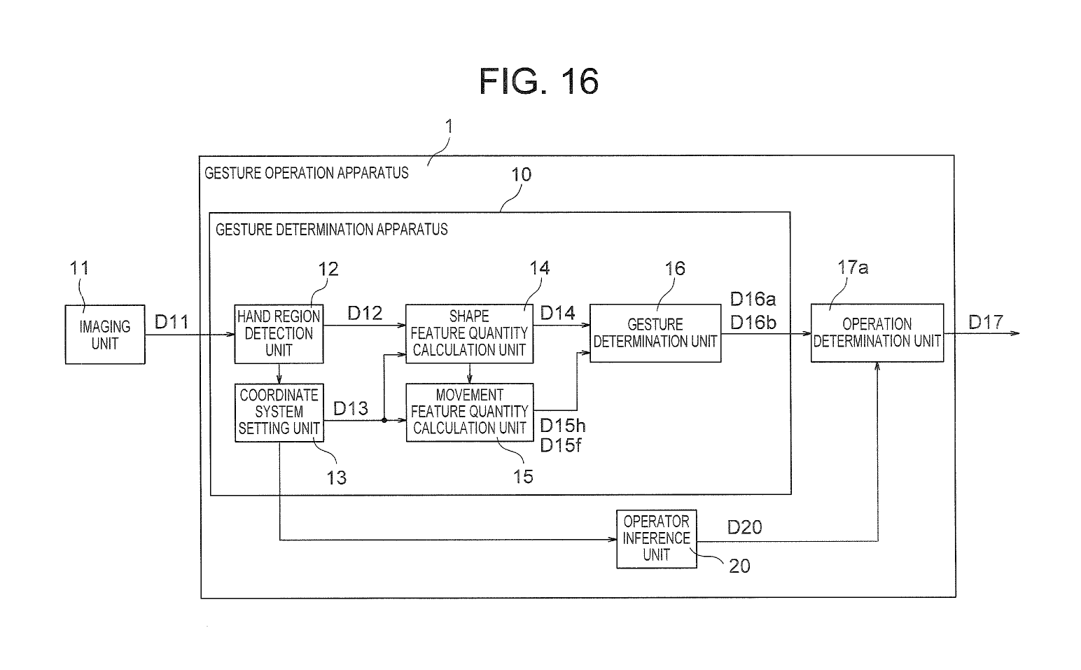

FIG. 16 is a block diagram showing the configuration of a gesture operation apparatus according to a third embodiment of this invention. The gesture operation apparatus shown in FIG. 16 is generally the same as the gesture operation apparatus shown in FIG. 2, and reference characters that are the same as in FIG. 2 indicate the same or equivalent parts.

The gesture operation apparatus shown in FIG. 16 is generally the same as the gesture operation apparatus shown in FIG. 2, but is different in that an operator inference unit 20 is added, and an operation determination unit 17a is provided in place of the operation determination unit 17.

The operator inference unit 20 infers the operator on the basis of either one or both of the origin coordinates and the relative angle of the hand coordinate system output by the coordinate system setting unit 13, and outputs operator information D20 to the operation determination unit 17a. The operator inference made here may be, for example, an inference of the seat in which the person operating the device is seated, or an inference of what person is operating the device. In the former case the operator information is, for example, an identification number corresponding to the seat; in the latter case the operator information is, for example, personal identification information.

For example, the operator inference unit 20 determines the position of the operator from either one or both of the origin coordinates and the relative angle of the hand coordinate system and generates the operator information. The position of the operator may be determined from, for example, the directions of the axes of the hand coordinate system. When the coordinate system setting unit 13 sets the second axis Chv of the hand coordinate system to the same direction as the vector directed from the wrist center to the palm center, if the relative angle θ of the hand coordinate system with respect to the image coordinate system is within the range of from −90 degrees to 0 degrees, the operator is inferred to be positioned in the lower left direction from the center of the image. If θ is within the range of from 0 degrees to 90 degrees, the operator is inferred to be positioned in the lower right direction from the center of the image. Here too it is assumed that an image taken from above the hand in the operation region 4 is obtained, as described in the first embodiment.

And, by matching the inferred position of the operator with the position of a seat, the operator information can then be determined. The operator information can also be determined by matching the position of the operator with a particular person.

The operation determination unit 17a determines a command on the basis of the information D16a indicating the gesture type and the parameters D16b pertaining to the gesture that are output from the gesture determination unit 16 and the operator information D20 output from the operator inference unit 20, and outputs the command thus determined.

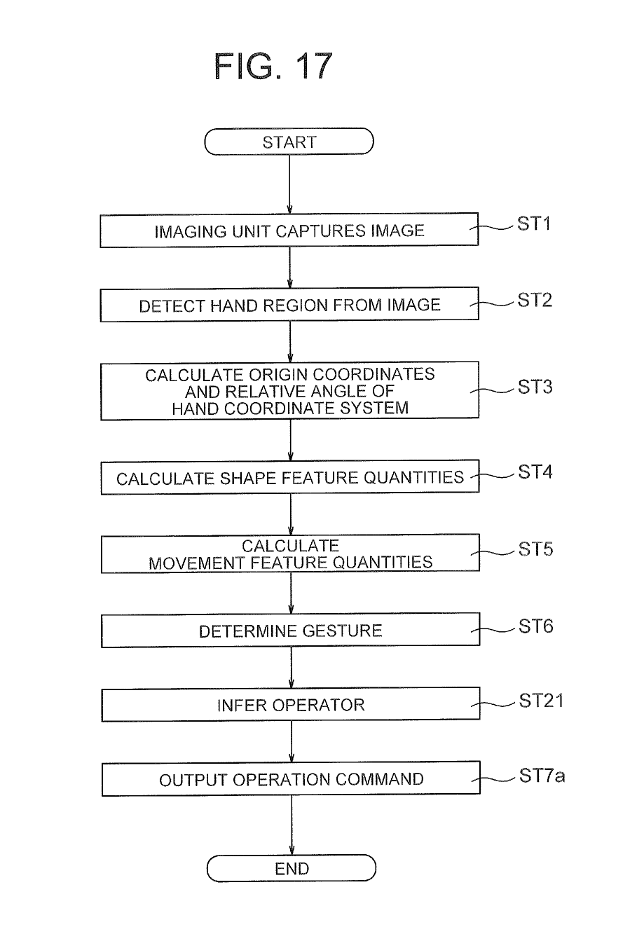

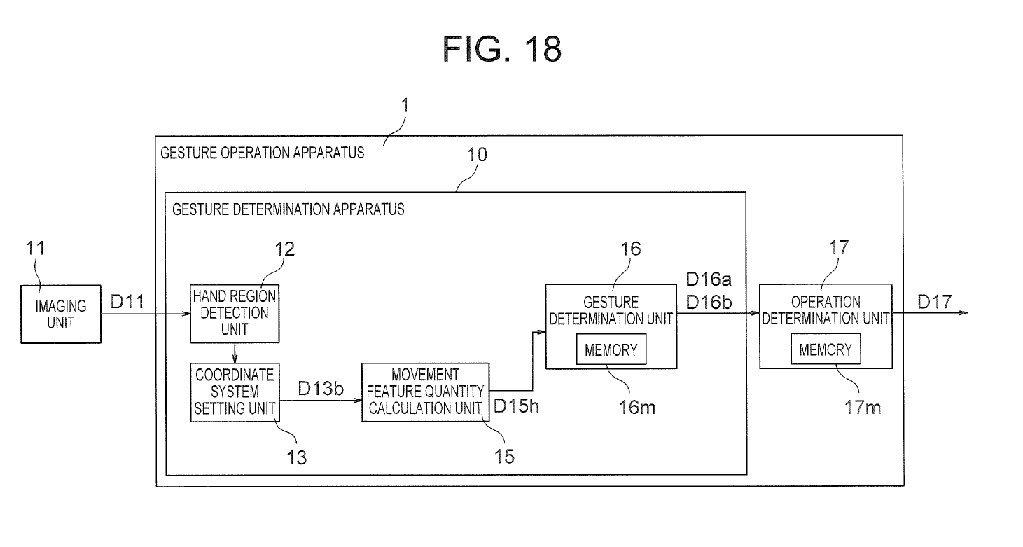

The processing procedure in the operation method executed by the gesture operation apparatus in the third embodiment will now be described by use of the flowchart in FIG. 17.

The operation method shown in FIG. 17 is generally the same as the method shown in FIG. 13, but differs in that a step ST21 is added, and a step ST7a is included in place of the step ST7. Reference characters in FIG. 17 that are the same as in FIG. 13 indicate identical or equivalent steps.

In the step ST21, the operator inference unit 20 infers the operator on the basis of either one or both of the origin coordinates and the relative angle of the hand coordinate system set in the step S3, and outputs the inference result to the operation determination unit 17a.

In the step ST7a, the operation determination unit 17a generates a command indicating the content of an operation from the information D16a indicating the gesture type and the parameters D16b pertaining to the gesture that are determined in the step ST6 and the operator information D20 generated by the inference made in the step ST21, and outputs the command to the operation control unit 5 or one of the operated devices 6a, 6b, 6c, and the process ends.

In the gesture operation apparatus according to the present embodiment configured as described above, the operator inference unit 20 is provided, so that even when the same gesture is performed in the operation region 4, the content of the operation (the type of operation and/or the amount of operation) can be changed according to the operator. For example, with one operator the ‘scissors’ gesture may denote selection of the ‘audio screen’, while with another operator, a ‘gesture in which only one finger is extended’ may denote selection of the ‘audio screen’. Different settings for different operators may also be made concerning the velocity of movement or the duration of gesture (the time for which the same shape is maintained or the time for which the same movement is continued). That is, by changing the correspondence between the gestures and the operation content according to the individual operator, a user-friendly gesture operation apparatus that takes account of operator preferences and characteristics can be realized.

For convenience of description, in the first to third embodiments, the image coordinate system and the hand coordinate system have been assumed to be orthogonal coordinate systems and also right-handed coordinate systems, but the invention is not limited to any particular type of coordinate system. The parameters of the hand coordinate system have been assumed to be the origin coordinates and the relative angle of the hand coordinate system, but the invention is not limited to these parameters; any parameters that enable the origin coordinates and the directions of the first axis and the second axis of the hand coordinate system to be determined from the image coordinate system may be used.

### Fourth Embodiment

In the first to third embodiments, the coordinate system setting unit 13 sets two coordinate axes Chu, Chv, but the invention is not limited to this scheme; the number of coordinate axes set may be one, or three or more. In short, it suffices for at least one coordinate axis to be set.

Also, the gesture determination have been carried out on the basis of shape feature quantities calculated by the shape feature quantity calculation unit 14 and the hand movement feature quantities or the finger movement feature quantities calculated by the movement feature quantity calculation unit 15, but the gesture determination may also be carried out on the basis of the hand movement feature quantities alone, without using the shape feature quantities and the finger movement feature quantities.

A configuration in which only one coordinate axis is set in the hand coordinate system and the gesture determination is carried out on the basis of the hand movement feature quantities alone will be described below.

FIG. 18 is a block diagram showing the configuration of a gesture operation apparatus according to a fourth embodiment of this invention. The gesture operation apparatus shown in FIG. 18 is generally the same as the gesture operation apparatus shown in FIG. 2, and reference characters that are the same as in FIG. 2 indicate identical or equivalent parts, but there are differences in that the shape feature quantity calculation unit 14 shown in FIG. 2 is not provided, a coordinate system setting unit 13b is provided in place of the coordinate system setting unit 13, a movement feature quantity calculation unit 15b is provided in place of the movement feature quantity calculation unit 15, and a gesture determination unit 16b is provided in place of the gesture determination unit 16.

First, a general description of the apparatus will be given.

From the hand region information D12 received as input, the coordinate system setting unit 13b determines the origin coordinates of the hand coordinate system in the image coordinate system and the relative angle of the hand coordinate system with respect to the image coordinate system, and outputs information representing these, as hand coordinate system parameters D13b, to the movement feature quantity calculation unit 15b.

On the basis of the hand coordinate system parameters D13b received from the coordinate system setting unit 13b, the movement feature quantity calculation unit 15b calculates the feature quantities (the hand movement feature quantities) of the hand movement (movement of the entire hand), generates information (hand movement feature quantity information) D15h indicating the calculated hand movement feature quantities, and outputs this information to the gesture determination unit 16b.

The gesture determination unit 16b compares the hand movement feature quantity information D15h received from the movement feature quantity calculation unit 15b with predefined reference values D15hr, discriminates the gesture type on the basis of the comparison results, generates the parameters pertaining to the gesture, and outputs the information D16a indicating the gesture type and the parameters D16b pertaining to the gesture to the operation determination unit 17.

The operations of the hand region detection unit 12 and the operation determination unit 17 are the same as those described in the first embodiment.

The operations of the coordinate system setting unit 13b, the movement feature quantity calculation unit 15b, and the gesture determination unit 16b will now be described in more detail.

From the hand region information D12 received from the hand region detection unit 12, the coordinate system setting unit 13b determines the origin coordinates of the hand coordinate system in the image coordinate system (the relative position of the origin of the hand coordinate system with respect to the origin of the image coordinate system) and the relative angle (angle of rotation) of the hand coordinate system with respect to the image coordinate system, and outputs the information representing these items as the hand coordinate system parameters D13b to the movement feature quantity calculation unit 15b.

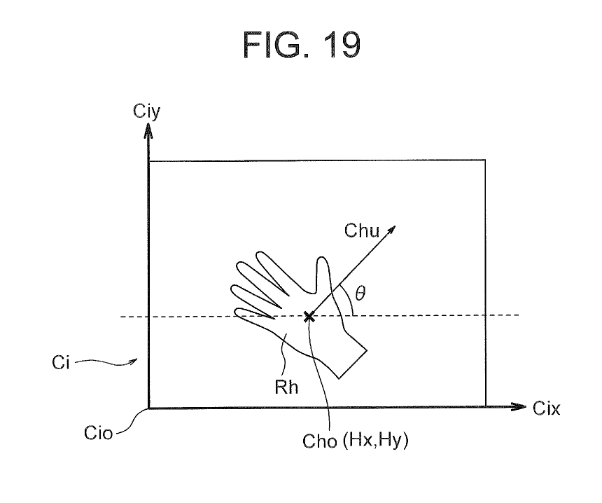

The image coordinate system and the hand coordinate system used in the fourth embodiment will be described here by use of FIG. 19.

FIG. 19 illustrates the relation between the image coordinate system Ci and the hand coordinate system Ch. As illustrated, only one coordinate axis Chu is set in the hand coordinate system.

The coordinate system setting unit 13b determines the coordinates (Hx, Hy) of the origin Cho of the hand coordinate system Ch in the image coordinate system Ci and determines the direction of the coordinate axis Chu in the hand coordinate system as described in the first embodiment.

For example, the coordinate system setting unit 13b sets the coordinates (Hx, Hy) of the palm center Po in the image coordinate system as the origin Cho (u=0, v=0) of the hand coordinate system as shown in FIG. 6.

Next it determines the direction of a vector perpendicular to the vector Dpw directed from the wrist center Wo to the palm center Po as the direction of the coordinate axis Chu of the hand coordinate system.

The direction of the coordinate axis Chu of the hand coordinate system is not limited to the example described above; it may be determined as any direction referenced to the vector directed from the wrist center Wo to the palm center Po. The vector serving as the reference is not limited to the vector directed from the wrist center Wo to the palm center Po; any vector connecting two arbitrary points in the hand may be used as the reference.

When the direction of the coordinate axis Chu of the hand coordinate system has been determined, the coordinate system setting unit 13b outputs information indicating that direction. For example, it outputs information indicating the relative angle θ of the hand coordinate system with respect to the image coordinate system.

The angle formed by the first axis Cix of the image coordinate system and the coordinate axis Chu of the hand coordinate system may be used as the relative angle of the hand coordinate system with respect to the image coordinate system, for example, or alternatively, the angle formed by the second axis Ciy of the image coordinate system Ci and the coordinate axis Chu of the hand coordinate system Ch may be used.

The counterclockwise angle formed by the axis Chu of the hand coordinate system with respect to the first axis of the image coordinate system will be used below as the relative angle θ of the hand coordinate system Ch with respect to the image coordinate system Ci.

The information indicating the above-mentioned relative angle θ is output together with the information indicating the origin coordinates (Hx, Hy) of the hand coordinate system in the image coordinate system as the hand coordinate system parameters D13b.

Next the processing in the movement feature quantity calculation unit 15b will be described. The movement feature quantity calculation unit 15b calculates the hand movement feature quantities D15h.

As the hand movement feature quantities D15h, at least one of the velocity, the acceleration, and the movement amount (the amount of movement from a certain position (initial position), for example) of the hand is calculated. The velocity and the movement amount are calculated on the basis of a difference in position over at least two different time points. The acceleration is calculated on the basis of a difference in the velocity over at least two different time points.

The movement feature quantity calculation unit 15b detects, for example, the movement of the palm center as the hand movement (movement of the entire hand).

It is advantageous to detect the hand movement on the basis of the component in the direction of the coordinate axis of the hand coordinate system. This is because when the hand is moved, it is easier for the operator to perceive and control the direction of movement with reference to the above-mentioned direction of the operator's own hand than with reference to a direction in the image generated by the imaging unit 11 (a direction in the image plane of the imaging unit 11).

Therefore, the movement amount r in a direction that forms a particular angle ε with respect to the coordinate axis of the hand coordinate system is calculated, and the hand movement feature quantities D15h are calculated on the basis thereof.

The movement amount per small interval of time (image capture period) Δr in the direction forming the particular angle ε with respect to the coordinate axis Chu is integrated to calculate a movement amount r. The movement amount r calculated in this way will be referred to below as ‘the movement amount in the direction forming the particular angle ε with respect to the hand coordinate system Ch(t) at each time point’. Also, the above-mentioned movement amount per unit time will be referred to as a velocity, and the change velocity per unit time will be referred to as an acceleration.

This movement amount r is calculated in the same way as the movement amounts p, q described in the first embodiment, as follows.

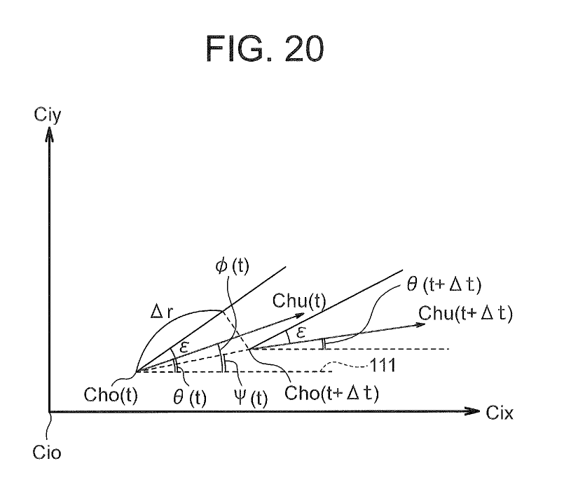

As shown in FIG. 20, if the origin and the relative angle of the hand coordinate at the time point t and the time point t+Δt change as shown in FIG. 20, the movement Δr during this time Δt is given by the formulas below, from the relations shown in FIG. 20.

[ Mathematical Expression 8]

Δr={square root over ((ΔHx(t)²+ΔHy(t)²)}·cos(φ(t)+ε) (10)

By integrating the Δr indicated in the formula (10), the movement amount r in the direction of ε at each time point can be determined.

In the example described above, a change in the central position of the palm is detected as the hand movement feature quantity D15h, but the invention is not limited to this scheme; for example, the amount of change in the position of the center of gravity of the hand region Rh may be detected, or the amount of change in the position of some other part of the hand may be detected as the hand movement feature quantity D15h.

The angle ε may have any value: for example, when ε=0, the movement amount, the velocity, and the acceleration in the direction of the coordinate axis of the hand coordinate system are calculated as the movement feature quantities D15h.

A plurality of angles c may be provided, denoted εk (k=1, 2, . . . , M, M≧1), and at least one of the movement amount, the velocity, and the acceleration in the directions εk of the hand coordinate system Ch(t) at each time point may be calculated as the movement feature quantities D15h.

Thus, with regard to the hand movement, the movement feature quantity calculation unit 15b converts the coordinate components in the image coordinate system to a component in a direction that forms a particular angle with respect to the hand coordinate system at each time point, uses the converted data to calculate the movement feature quantities D15h, and outputs the calculated results to the gesture determination unit 16b.

Together with the hand movement component in a direction forming a particular angle ε or angles εk as described above, the movement feature quantity calculation unit 15b also outputs information indicating the particular angle ε or angles εk to the gesture determination unit 16b.

The gesture determination unit 16b determines the type of hand movement gesture on the basis of the movement feature quantities input from the movement feature quantity calculation unit 15b, outputs information D16a indicating the result of the determination to the operation determination unit 17, calculates the feature quantities of the gesture, and outputs information representing the calculated feature quantities, as the parameters D16b pertaining to the gesture, to the operation determination unit 17.

In the gesture determination from the hand movement, for example, a determination that a certain type of gesture (a gesture for the purpose of a certain operation input) has been performed is made when movement in a direction forming a certain particular angle with respect to the straight line connecting the wrist center and the palm center in the image coordinate system (that is, a direction that forms a certain particular angle with respect to the coordinate axis Chu of the hand coordinate system at each time point) continues, and the velocity of the movement, the time for which the movement continues, or the movement amount in the direction that forms the above-mentioned particular angle satisfies a predetermined condition (for example, that the movement in the certain particular direction in the hand coordinate system at each time point is within a predetermined velocity range and continues for a predetermined time or more).

For the purpose of that determination, with regard to the movement in a direction forming a certain particular angle with respect to the straight line connecting the wrist center and the palm center in the image coordinate system (that is, a direction that forms a certain particular angle with respect to the coordinate axis Chu of the hand coordinate system at each time point), the condition to be satisfied by the velocity of the movement, the time for which the movement continues, or the movement amount in the direction that forms the above-mentioned particular angle is predefined and stored in the memory 16m.

During the gesture determination process, when the movement feature quantities D15h calculated by the movement feature quantity calculation unit 15b from the image data D11 output from the imaging unit 11 satisfy the above-mentioned condition, a determination is made that the certain type of gesture mentioned above has been performed.

Although one coordinate axis has been set in the hand coordinate system, the number of coordinate axes that are set is not limited to one; it may be two or three. That is, two or more coordinate axes may be set, and the movement amount, the velocity, the acceleration, and so on in the direction of each coordinate axis may be calculated.

When two or more coordinate axes are set, for the coordinate axes other than the first axis, a direction that forms a particular angle referenced to the first axis may be designated as the axial direction, or the direction of each coordinate axis may be set separately, referenced to the positions of parts of the hand.

The configuration may also be combined with the shape feature quantity calculation unit 14, as shown in FIG. 2, to determine a gesture which is a combination of a hand movement and a hand shape gesture.

In the gesture determination apparatus 10 according to the present embodiment configured as described above, the hand coordinate system is set by the coordinate system setting unit 13b and the movement feature quantities D15h are calculated on the basis of the hand coordinate system, so that accurate gesture determination can be made, unaffected by differences in the angle of the hand in the operation region 4 and differences in the direction of the movement of the hand-waving actions and the like, which differ depending on the individual operator, with fewer misrecognitions.

The features described in the second and third embodiments may be combined with the features described in the fourth embodiment.

In the descriptions of the first to fourth embodiments the invention has been described as being applied to the operation of vehicle mounted devices, but this does not limit the invention; it may be applied to the operation of household electrical appliances, information devices, and industrial devices.

The gesture operation apparatus and the gesture determination apparatus according to the present invention have been described above, but the gesture operation methods carried out by the gesture operation apparatus and the gesture determination methods carried out by the gesture determination apparatuses also form part of the invention. Furthermore, some of the constituent elements of the gesture operation apparatuses or the gesture determination apparatuses and some of the processes in the gesture operation methods and the gesture determination methods may be implemented in software, that is, by a programmed computer. Programs for executing some of the constituent elements of the above-mentioned apparatuses and some of the processes in the above-mentioned methods on a computer and computer readable recording media in which these programs are stored accordingly also form part of the present invention.

### REFERENCE CHARACTERS

1 gesture operation apparatus, 2 seat, 4 operation region, 5 operation control unit, 6a map guidance device, 6b audio device, 6c air conditioner, 10 gesture determination apparatus, 11 imaging unit, 12 hand region detection unit, 13, 13a, 13b coordinate system setting unit, 14 shape feature quantity calculation unit, 15, 15b movement feature quantity calculation unit, 16 gesture determination unit, 17, 17a operation determination unit, 18 mode control unit, 19 memory, 20 operator inference unit, Ch hand coordinate system, Ci image coordinate system, Rh hand region.

1. A gesture determination apparatus comprising:
a hand region detection unit for detecting a hand region of an operator including palm center and a wrist center from a captured image and outputting hand region information indicating the detected hand region;
a coordinate system setting unit for setting an origin coordinate of a hand coordinate system and at least one coordinate axis of said hand coordinate system from a position of a particular part of a hand of the operator, based on said hand region information;
a movement feature quantity calculation unit for calculating a movement feature quantity of the hand of the operator on a basis of changes in said hand coordinate system; and
a gesture determination unit for determining a gesture type, and calculating a gesture feature quantity, from the movement feature quantity of the hand.

2. (canceled)

3. (canceled)

4. The gesture determination apparatus as set forth in claim 1, further comprising:
a shape feature quantity calculation unit for identifying, as a finger candidate region, a part of the hand region indicated by the hand region information that satisfies a condition determined using said hand coordinate system, detecting a hand shape in the identified finger candidate region, and calculating a shape feature quantity representing a feature of the hand shape, wherein:
said movement feature quantity calculation unit also calculates a movement feature quantity of a finger of the operator on a basis of said hand coordinate system and the shape feature quantity; and
said gesture determination unit determines the gesture type and calculates the gesture feature quantity on a basis not only of the movement feature quantity of the hand but also of the movement feature quantity of the finger and the shape feature quantity.

5. A gesture determination apparatus comprising:
a hand region detection unit for detecting a hand region of an operator including palm center and a wrist center from a captured image and outputting hand region information indicating the detected hand region;
a coordinate system setting unit for setting an origin coordinate of a hand coordinate system and at least one coordinate axis of said hand coordinate system from a position of a particular part of a hand of the operator, based on said hand region information;
a shape feature quantity calculation unit for identifying, as a finger candidate region, a part of the hand region indicated by said hand region information that satisfies a condition determined using said hand coordinate system, detecting a hand shape in the identified finger candidate region, and calculating a shape feature quantity representing a feature of the hand shape;
a movement feature quantity calculation unit for performing at least one of a calculation of a movement feature quantity of the hand of the operator on a basis of said hand coordinate system and a calculation of a movement feature quantity of a finger of the operator on a basis of changes in said hand coordinate system and the shape feature quantity; and
a gesture determination unit for determining a gesture type, and calculating a gesture feature quantity, from at least one of the movement feature quantity of the hand and the movement feature quantity of the finger, and from the shape feature quantity.

6. (canceled)

7. (canceled)

8. The gesture determination apparatus as set forth in claim 1, wherein said gesture determination unit determines the gesture type, and calculates the gesture feature quantity, by comparing the movement feature quantity output by said movement feature quantity calculation unit with a predefined movement feature quantity reference value on a basis of the hand coordinate system.

9. (canceled)

10. The gesture determination apparatus as set forth in claim 1, further comprising:
a memory for storing part of parameters of said hand coordinate system; and
a mode control unit for designating one or the other of a coordinate system setting mode and a feature quantity calculation mode; wherein
when said coordinate system setting mode is designated by said mode control unit, said coordinate system setting unit calculates, and has said memory store, the part of the parameters of said hand coordinate system; and
when said feature quantity calculation mode is designated by said mode control unit, said movement feature quantity calculation unit calculates the movement feature quantity of the hand or the movement feature quantity of the finger, using said part of the parameters stored in said memory.

11. The gesture determination apparatus as set forth in claim 4, wherein said condition is determined on a basis of an origin of said hand coordinate system and a direction of said at least one coordinate axis of said hand coordinate system.

12. (canceled)

13. The gesture determination apparatus as set forth in claim 4, further comprising:
a memory for storing part of parameters of said hand coordinate system; and
a mode control unit for designating one or the other of a coordinate system setting mode and a feature quantity calculation mode; wherein
when said coordinate system setting mode is designated by said mode control unit, said coordinate system setting unit calculates, and has said memory store, the part of the parameters of said hand coordinate system; and
when said feature quantity calculation mode is designated by said mode control unit, said shape feature quantity calculation unit calculates the shape feature quantity, using said part of the parameters stored in said memory.

14. The gesture determination apparatus as set forth in claim 10, wherein the part of the parameters of said hand coordinate system is information indicating an angle formed by at least one coordinate axis of a coordinate system of the captured image and said at least one coordinate axis of said hand coordinate system.

15: (canceled)

16: (canceled)

17. A gesture operation apparatus comprising:
the gesture determination apparatus as set forth in claim 1; and
an operation determination unit for determining operation content from the gesture type determined by the gesture determination apparatus and the gesture feature quantity calculated by the gesture determination apparatus, and generating and outputting a command indicating the determined operation content.

18. The gesture operation apparatus as set forth in claim 17, further comprising an operator inference unit for inferring the operator on a basis of the origin coordinate set by said coordinate system setting unit and a direction of said at least one coordinate axis, wherein:
said operation determination unit determines the operation content on a basis of the gesture type determined by said gesture determination unit, the gesture feature quantity calculated by said gesture determination unit, and the operator inferred by said operator inference unit.

19. A gesture determination method comprising:
a hand region detection step for detecting a hand region of an operator including palm center and a wrist center from a captured image and outputting hand region information indicating the detected hand region;
a coordinate system setting step for setting an origin coordinate of a hand coordinate system and at least one coordinate axis of said hand coordinate system from a position of a particular part of a hand of the operator, based on said hand region information;
a movement feature quantity calculation step for calculating a movement feature quantity of the hand of the operator on a basis of changes in said hand coordinate system; and
a gesture determination step for determining a gesture type, and calculating a gesture feature quantity, from the movement feature quantity of the hand.

20. A gesture determination method comprising:
a hand region detection step for detecting a hand region of an operator including palm center and a wrist center from a captured image and outputting hand region information indicating the detected hand region;
a coordinate system setting step for setting an origin coordinate of a hand coordinate system and at least one coordinate axis of said hand coordinate system from a position of a particular part of a hand of the operator, based on said hand region information;
a shape feature quantity calculation step for identifying, as a finger candidate region, a part of the hand region indicated by said hand region information that satisfies a condition determined using said hand coordinate system, detecting a hand shape in the identified finger candidate region, and calculating a shape feature quantity representing a feature of the hand shape;
a movement feature quantity calculation step for performing at least one of a calculation of a movement feature quantity of the hand of the operator on a basis of said hand coordinate system and a calculation of a movement feature quantity of a finger of the operator on a basis of changes in said hand coordinate system and the shape feature quantity; and
a gesture determination step for determining a gesture type, and calculating a gesture feature quantity, from at least one of the movement feature quantity of the hand and the movement feature quantity of the finger, and from the shape feature quantity.

21: (canceled)

22: (canceled)

23. The gesture determination apparatus as set forth in claim 5, wherein said gesture determination unit determines the gesture type, and calculates the gesture feature quantity, by comparing the movement feature quantity output by said movement feature quantity calculation unit with a predefined movement feature quantity reference value on a basis of the hand coordinate system.

24. The gesture determination apparatus as set forth in claim 5, further comprising:
a memory for storing part of parameters of said hand coordinate system; and
a mode control unit for designating one or the other of a coordinate system setting mode and a feature quantity calculation mode; wherein
when said coordinate system setting mode is designated by said mode control unit, said coordinate system setting unit calculates, and has said memory store, the part of the parameters of said hand coordinate system; and
when said feature quantity calculation mode is designated by said mode control unit, said movement feature quantity calculation unit calculates the movement feature quantity of the hand or the movement feature quantity of the finger, using said part of the parameters stored in said memory.

25. The gesture determination apparatus as set forth in claim 5, wherein said condition is determined on a basis of an origin of said hand coordinate system and a direction of said at least one coordinate axis of said hand coordinate system.

26. The gesture determination apparatus as set forth in claim 5, further comprising:
a memory for storing part of parameters of said hand coordinate system; and
a mode control unit for designating one or the other of a coordinate system setting mode and a feature quantity calculation mode; wherein
when said coordinate system setting mode is designated by said mode control unit, said coordinate system setting unit calculates, and has said memory store, the part of the parameters of said hand coordinate system; and
when said feature quantity calculation mode is designated by said mode control unit, said shape feature quantity calculation unit calculates the shape feature quantity, using said part of the parameters stored in said memory.

27. The gesture determination apparatus as set forth in claim 24, wherein the part of the parameters of said hand coordinate system is information indicating an angle formed by at least one coordinate axis of a coordinate system of the captured image and said at least one coordinate axis of said hand coordinate system.

28. A gesture operation apparatus comprising:
the gesture determination apparatus as set forth in claim 5; and
an operation determination unit for determining operation content from the gesture type determined by the gesture determination apparatus and the gesture feature quantity calculated by the gesture determination apparatus, and generating and outputting a command indicating the determined operation content.

29. The gesture operation apparatus as set forth in claim 28, further comprising an operator inference unit for inferring the operator on a basis of the origin coordinate set by said coordinate system setting unit and a direction of said at least one coordinate axis, wherein:
said operation determination unit determines the operation content on a basis of the gesture type determined by said gesture determination unit, the gesture feature quantity calculated by said gesture determination unit, and the operator inferred by said operator inference unit.
